(19) United States
(12) Patent Application Publication
(10) Pub. No.: US 2014/0095130 A1
(43) Pub. Date: Apr. 3, 2014

(54) Prespacetime model for generating energy-momentum-mass relationship, self-referential matrix rules and elementary particles

(71) Applicant: Huping Hu, Stony Brook, NY (US)

(72) Inventor: Huping Hu, Stony Brook, NY (US)

(21) Appl. No.: 14/092,802

(22) Filed: Nov. 27, 2013

Related U.S. Application Data
(63) Continuation of application No. 12/973,633, filed on Dec. 20, 2010.

(51) Int. Cl. G06F 17/10

(52) U.S. Cl. CPC G06F 17/10
USPC 703/2

(57) ABSTRACT

A prespacetime model is formulated for generating energy-momentum-mass relationship, elementary particles and self-referential matrix rules through hierarchical self-referential spin structure in prespacetime. Key to the present model is: (1) generation of at least one primordial phase distinction in prespacetime, (2) formation of energy-momentum-mass relationship from said phase distinction; (3) formation of external and internal objects from said phase distinction; (4) matrixization of said energy-momentum-mass relationship into matrix rules; (5) matrixization of said internal and external objects into the external and internal wave functions of a particle in the dual world, and (6) interaction of said external object and said internal object through said matrix rules. In particular, working models for generating energy-momentum-mass relationship, self-referential matrix rules, elementary particles and composite particles are described as research aids, teaching tools and games. Further, working model for ether (aether) as a body or medium of prespacetime is also described as research aids and teaching tools.

This application is a continuation application of U.S. patent application Ser. No. 12/973,633 filed on Dec. 20, 2010, which claims priority from U.S. provisional application Ser. No. 61/288,333 filed Dec. 20, 2009, which applications are fully incorporated herein by reference.

### FIELD OF THE INVENTION

The invention herein relates to model for generating energy-momentum-mass relationship, self-referential matrix rules, elementary particles and composite particles through self-referential hierarchical spin in prespacetime. In particular, working models for generating energy-momentum-mass relationship, self-referential matrix rules, elementary particles and composite particles are described as research aides, teaching tools and games. Further, working model for ether (aether) as medium of prespacetime is also described as research aids and teaching tools.

### BACKGROUND OF THE INVENTION

Many experiments have shown that quantum entanglement is physically real (see Aspect, A., Dalibard, j., & Roger, G. Experimental test of Bell's inequalities using time-varying analyzers. Phys. Rev. Lett. 49, 1804-1807 (1982)). It is ubiquitous in the microscopic world and manifests itself macroscopically under some circumstances (see Ghosh, S., Rosenbaum, T. F., Aeppli, G. & Coppersmith, S. N. Entangled quantum state of magnetic dipoles. Nature 425, 48-51 (2003)). However, the essence and implications of quantum entanglement are still hotly debated. For example, it is commonly believed that quantum entanglement alone cannot be used to transmit binary or classical information. Further, despite of the fact that all interactions in biological systems at molecular and sub-molecular levels are quantum interactions in nature, it is commonly believed that quantum effects do not play any roles in biological functions such as brain functions due to quantum decoherence (see Tegmark, M. The importance of quantum decoherence in brain processes. Phys. Rev., 61E: 4194 (2000)).

Yet, I have recently discovered non-local effects of chemical substances on biological systems such as a human brain produced through quantum entanglement (Hu, H. P., & Wu, M. X. Photon induced non-local effect of general anesthetics on the brain. NeuroQuantology 4, 17-31 (2006), Hu, H. P., & Wu, M. X. Non-local effects of chemical substances on the brain produced through quantum entanglement. Progress in Physics v3, 20-26 (2006)). I have also discovered evidence of non-local chemical, thermal and gravitational effects produced through quantum entanglement (Hu, H. P., & Wu, M. X. Evidence of non-local physical, chemical and biological effects supports quantum brain. NeuroQuantology 4, 291-306 (2006); Hu, H. P., & Wu, M. X. Evidence of non-local chemical, thermal and gravitational effects. Progress in Physics v2, 17-21 (2007)).

My invention and discovery were made against such background. No model has previously been known which can model the generation of energy-momentum-mass relationship, self-referential matrix rules, elementary particles and composite particles through self-referential hierarchical spin structures of prespacetime. Further, No model has previously been known which can model ether (aether) as the medium of prespacetime.

### SUMMARY OF THE INVENTION

I have now invented prespacetime model for modeling the generation of energy-momentum-mass relationship, self-referential matrix rules, elementary particles and composite through self-referential hierarchical spin structures of prespacetime. I have now also invented the model of ether (aether) as the medium of prespacetime.

The subject invention is originated from my research on self-reference, nature of spin, consciousness, brain functions and nature of quantum entanglement. I have theorized that spin is a primordial self-referential process driving quantum mechanics, spacetime dynamics and consciousness (Hu, H. P. & Wu, M. X. Spin as primordial self-referential process driving quantum mechanics, spacetime dynamics and consciousness. NeuroQuantology, 2, 41-49 (2004); also see Cogprints ID2827 (2003)). I have also theorized that spin is a mind-pixel and the nuclear and/or electronic spins inside brain play important roles in certain aspects of brain functions such as perception (Hu, H. P., & Wu, M. X. Spin-mediated consciousness theory. Medical Hypotheses 63, 633-646 (2004); also see arXiv e-print quant-ph/0208068v1 (2002)).

Further, I have discovered the non-local effects of chemical substances on biological systems such as a human brain produced through quantum entanglement (Hu, H. P., & Wu, M. X. Photon induced non-local effect of general anesthetics on the brain. NeuroQuantology 4, 17-31 (2006), Hu, H. P., & Wu, M. X. Non-local effects of chemical substances on the brain produced through quantum entanglement. Progress in Physics v3, 20-26 (2006)). I have also discovered the evidence of non-local chemical, thermal and gravitational effects produced through quantum entanglement (Hu, H. P., & Wu, M. X. Evidence of non-local physical, chemical and biological effects supports quantum brain. NeuroQuantology 4, 291-306 (2006); Hu, H. P., & Wu, M. X. Evidence of non-local chemical, thermal and gravitational effects. Progress in Physics v2, 17-21 (2007)).

The subject invention is based on my realization that in the beginning there was prespacetime alone (e⁰=1) materially empty but wants to express itself. So, it began to imagine through primordial self-referential spin.

1=eⁱ⁰=eⁱ⁰eⁱ⁰=e^{iL-iL}e^{iM-iM}=e^{iL}e^{iM}e^{-iL}e^{-iM}=e^{-iL}e^{-iM}/e^{-iL}e^{-iM}=e^{iL}e^{iM}/e^{iL}e^{iM} . . . such that it created the self-referential matrix rules, the external object to be observed and internal object as observed, separated them into external world and internal world, caused them to interact through said matrix rules and thus gave birth to the Universe which it has since sustained and made to evolve.

The prespacetime model employs the following ontological principles among others are: (1) principle of oneness/unity of existence through quantum entanglement in the ether of prespacetime; and (2) principle of hierarchical primordial self-referential spin creating: (a) energy-momentum-mass relationship as transcendental law of one, (b) energy-momentum-mass relationship as determinant of matrix rules, (c) dual-world law of zero of energy, momentum & mass, (d) immanent law of conservation of energy, momentum & mass in external or internal world which may be violated in certain processes.

The prespacetime model further employs the following mathematical elements & forms among others in order to empower the above ontological principles among others: (1) e, Euler's number, for (to empower) ether (aether) as foundation/basis/medium of existence (body of prespacetime); (2) i, imaginary number, for (to empower) thoughts and imagination; (3) 0, zero, for (to empower) emptiness/undifferentiated/primordial state; (4) 1, one, for (to empower) oneness/unity of existence; (5)+, −, *, /, = for (to empower) creation, dynamics, balance & conservation; (6) Pythagorean theorem for (to empower) energy-momentum-mass relationship; and (7) M, matrix, for (to empower) the external and internal worlds (the Dual World) and the interaction of external and internal worlds.

Key to the present model is: (1) generation of at least one primordial phase distinction through imagination i in the prespacetime, (2) formation of energy-momentum-mass relationship from said phase distinction; (3) formation of external and internal objects from said phase distinction; (4) matrixization of said energy-momentum-mass relationship into matrix rules; (5) matrixization of said internal and external objects into the external and internal wave functions of a particle in the dual world, and (6) said interaction of the external and internal wave functions through said matrix rules.

The prespacetime model provides for interactions of the external and internal worlds through quantum entanglement since I have experimentally demonstrated that gravity is the manifestation of quantum entanglement (Hu, H. P., & Wu, M. X. Evidence of non-local physical, chemical and biological effects supports quantum brain. Neuro-Quantology 4, 291-306 (2006); Hu, H. P., & Wu, M. X. Evidence of non-local chemical, thermal and gravitational effects. Progress in Physics v2, 17-21 (2007)).

The prespacetime model provides for interactions within the external world through classical and relativistic physical laws with light speed c as the speed limit of the external interactions and influences of the internal world on the external objects in the external world through as gravity macroscopically and quantum effects microscopically. Thus, according to the prespacetime model, the interactions within the external world and/or the internal world are local interactions and conform to special theory of relativity, but the interactions across the dual world are non-local interactions, that is, quantum entanglement or gravity.

My prespacetime model may be more completely understood by reference to the following detailed description considered in connection with the accompanying drawings. However, it should be understood that the drawings are designed for purposes of illustration only and not as a definition of the limits of the invention.

### BRIEF DESCRIPTION OF THE DRAWINGS

FIG. 1 is a schematic view of the generation of two primordial phase distinctions according to the prespacetime model producing two set of external and internal phase distinctions in the prespacetime.

FIG. 2 is a schematic view of a matrix equation according to the prespacetime model illustrating a relationship among the external object, the internal object and the matrix rule.

FIG. 3 is another schematic view of the matrix equation according to the prespacetime model illustrating interaction between the external and internal object of an entity/particle through the matrix rule.

FIG. 4 is a schematic and mathematical view of self-referential hierarchical spin generating energy-momentum-mass relationship and creating, sustaining and making evolving elementary particles according to the prespacetime model.

FIG. 5 to FIG. 11 is schematic and mathematical views of metamorphous self-referential spin processes generating different forms of the matrix rule according to the prespacetime model.

FIG. 12 is schematic and mathematical views of a matrix game for generating different forms of the matrix rule according to the prespacetime model.

FIG. 13 to FIG. 21 is schematic and mathematical views of metamorphous self-referential hierarchical spin processes creating, sustaining and making evolving elementary entities or particles according to the prespacetime model.

FIG. 22 to FIG. 25 is schematic and mathematical views of the metamorphous self referential hierarchical spin processes creating, sustaining and making evolving composite entities or particles such as a neutron and a hydrogen atom according to the prespacetime model.

FIG. 26 is schematic and mathematical views of the roles of ether (aether) as medium of prespacetime according the prespacetime model.

### DETAILED DESCRIPTION OF THE INVENTION

The detailed description of the prespacetime model is organized into 4 sections.

### I. Overall Scheme of the Prespacetime Model

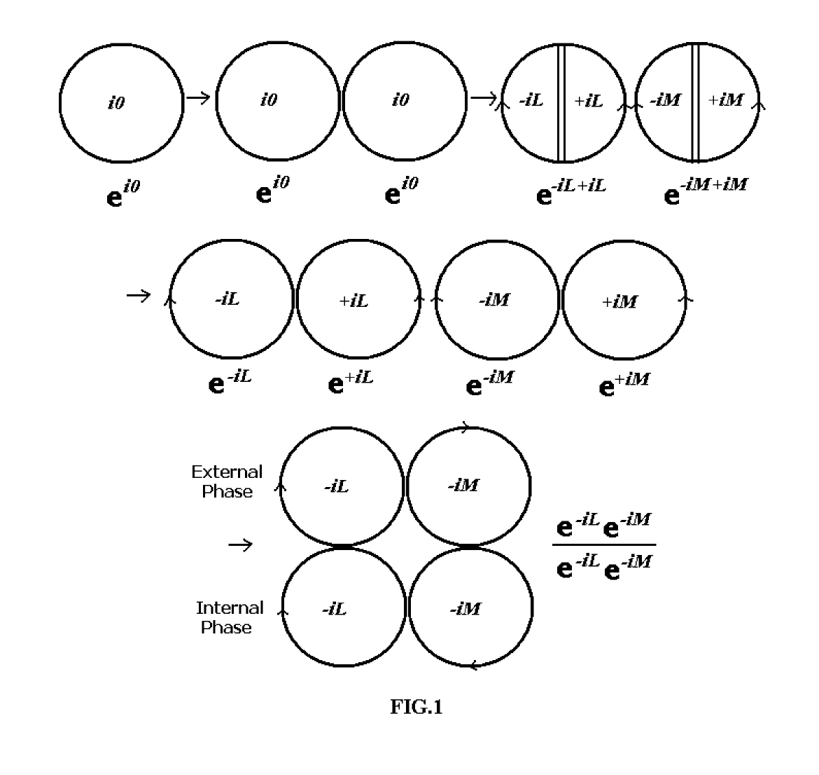

FIG. 1 to FIG. 4 illustrates an overall scheme of the prespacetime model including: (1) generation of at least one primordial phase distinctions through imagination i in the prespacetime, (2) formation of energy-momentum-mass relationship from said phase distinction; (3) formation of external and internal objects from said phase distinction; (4) matrixization of said energy-momentum-mass relationship into matrix rules; (5) matrixization of said internal and external objects into the external and internal wave functions of a particle in the dual world, and (6) said interaction of the external and internal wave functions through said matrix rules.

Considering first FIG. 1, the prespacetime model includes the generation of a first primordial phase distinction comprised of −L and +L and a second primordial phase distinction comprised of −M and +Min the mind of the prespacetime through the imagination i of the prespacetime above the body of the prespacetime which can also be expressed as 1=eⁱ⁰=eⁱ⁰eⁱ⁰=e^{-iL+iL}e^{-iM+iM}=e^{-iL}e^{+iL}e^{-iM}e^{+iM}=e^{-iL}e^{-iM}/e^{-iL}e^{-iM}. In one particular embodiment, L is an angle ∠Em of a right triangle comprised of energy (E), momentum (|p|) and mass (m), and M=(Et−p·r)/ [symbol] =p^{μ}x_{μ}/ [symbol] .

The primordial phase distinctions are accompanied by formation of energy-momentum-mass relationship from said first phase distinction and formation of external and internal objects from said second phase distinction.

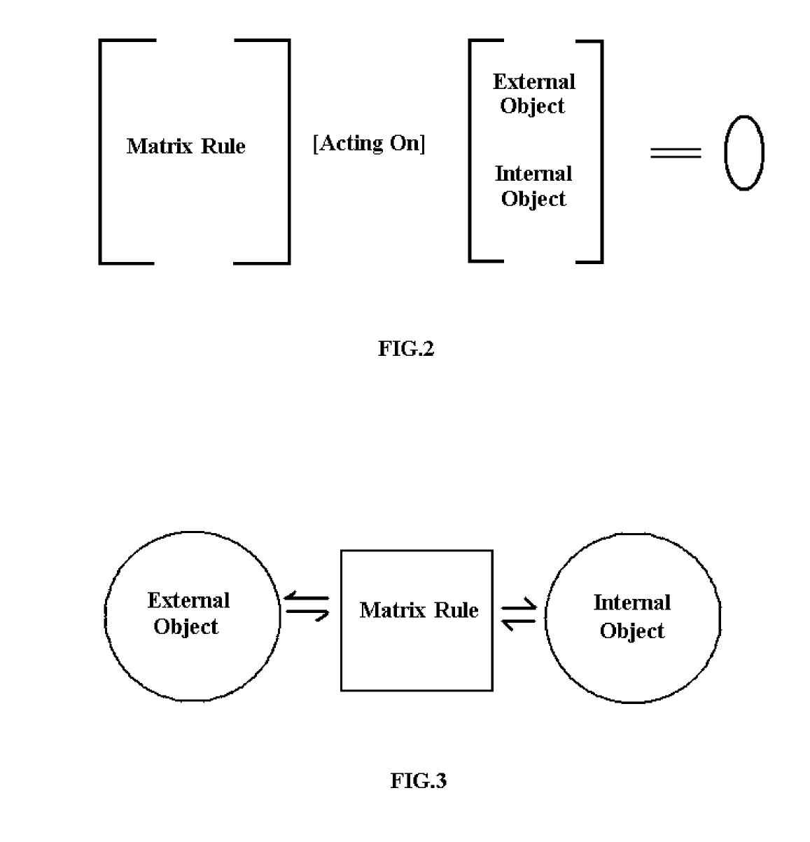

Considering FIG. 2 & FIG. 3, the prespacetime model includes the external and internal objects, matrix rules, and interactions between the external object and the internal object through said matrix rules.

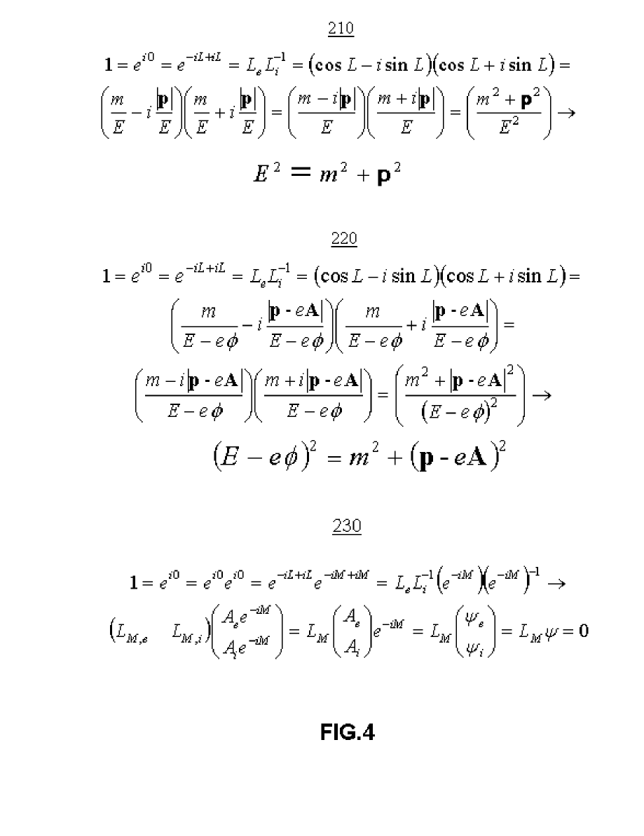

Considering FIG. 4, expression 210 shows formation of a first energy-momentum-mass relationship through self-referential spin in prespacetime, expression 220 shows formation of a second energy-momentum-mass relationship in presence of an external electrical potential A^{μ}=(φ, A), and expression 230 shows generation of primordial phase distinctions, formation of the matrix rule, formation of external wave function and internal wave function, interaction between said external and internal wave functions through said matrix rules.

In FIGS. 1 & 4, e is Euler number representing prespacetime body (ether or aether), i is imaginary unit representing imagination in prespacetime, ±M is immanent content of imagination i such as space, time, momentum & energy, ±L is immanent law of imagination i, L₁=eⁱ⁰=e^{-iL+iL}=LₑLᵢ⁻¹=1 is transcendental law of one in prespacetime before matrixization, Lₑ is external law, Lᵢ is internal law, L_{M,e} is external matrix law, and L_{M,e} is internal matrix law, L_{M} is the self-referential Matrix Law in prespacetime comprised of external and internal matrix laws which governs elementary entities and conserves zero, Ψₑ is external wave function (external object), Ψᵢ is internal wave function (internal object) and Ψ is the complete wave function (object/entity in the dual-world as a whole). Prespacetime spins as 1=eⁱ⁰=eⁱ⁰eⁱ⁰=e^{iL-iL}e^{iM-iM}=e^{iL}e^{iM}e^{-iL}e^{-iM}=e^{-iL}e^{-iM}/e^{-iL}e^{-iM}=e^{iL}e^{iM}/e^{iL}e^{iM} . . . before matrixization. Prespacetime also spins through self-acting and self-referential Matrix Law L_{M} after matrixization which acts on external object and internal object to cause them to interact with each other as further described below.

The prespacetime model provides for interactions of the external and internal worlds through quantum entanglement since I have experimentally demonstrated that gravity is the manifestation of quantum entanglement (Hu, H. P., & Wu, M. X. Evidence of non-local physical, chemical and biological effects supports quantum brain. Neuro-Quantology 4, 291-306 (2006); Hu, H. P., & Wu, M. X. Evidence of non-local chemical, thermal and gravitational effects. Progress in Physics v2, 17-21 (2007)).

### II. Generation of Self-Referential Matrix Rules

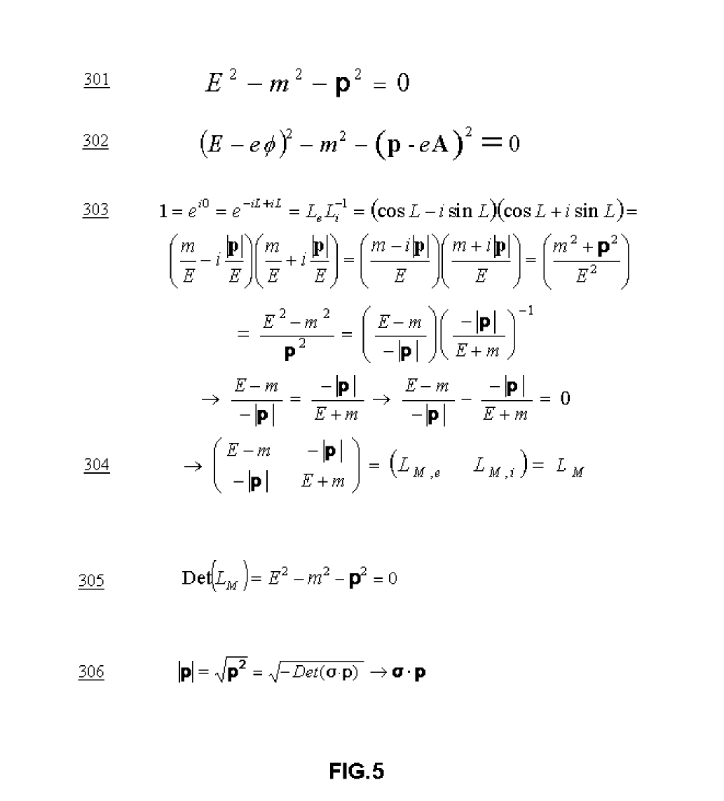

In the prespacetime model, the energy-momentum-mass relationship 301 of FIG. 5 is created from primordial self-referential spin 210 of FIG. 4. For simplicity, c=1 is used in 210 and further c= [symbol] =1 will be utilized through out this application. 301 was discovered by Einstein. In the presence of an interacting field of a second entity such as an electromagnetic potential A^{μ}=(φ, A), expression 210 becomes expression 220 and expression 301 becomes expression 302.

In the prespacetime model, one form of matrix rule L_{M} in prespacetime is created from the primordial self-referential spin in expressions 303 & 304 of FIG. 5 where matrixization step is carried out in such way that Determinant 305 of FIG. 5 holds in order to satisfy the fundamental relationship 301 in the determinant view.

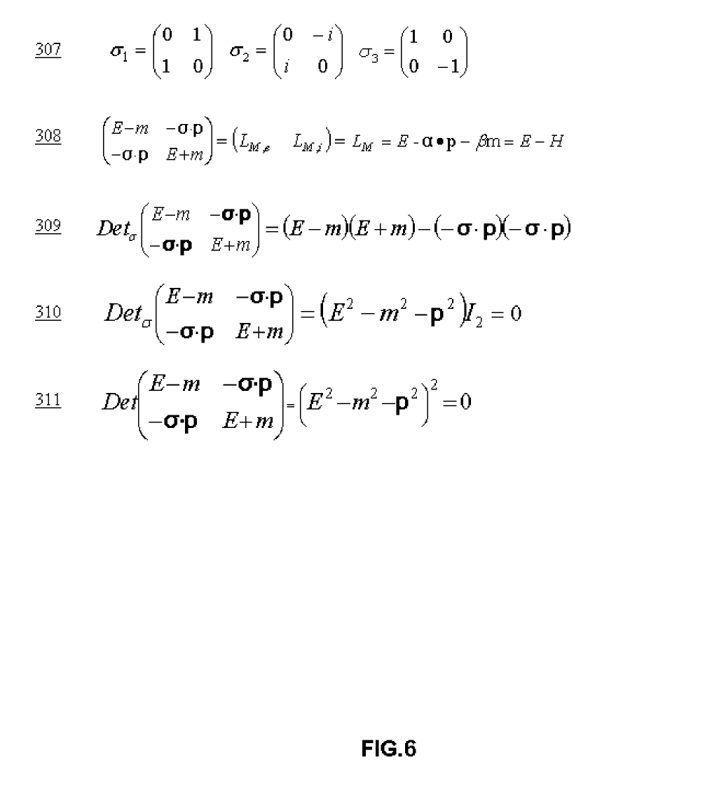

After spinization 306, expression 304 of FIG. 5 becomes 308 of FIG. 6 where α=(α₁, α₂, α₃) and β are Dirac matrices and H=α*p+βm is the Dirac Hamiltonian. Expression 308 governs fermions in Dirac form such as Dirac electron and positron and expression 304 governs the third state of matter (unspinized or spinless entity/particle) with electric charge e and mass m such as a meson or a meson-like particle.

From definition 309 of FIG. 6, a result in 310 of FIG. 6 is obtained. Thus, fundamental relationship 301 of FIG. 5 is also satisfied under the determinant view of expression 309. Indeed, a second result in 311 of FIG. 6 can also be obtained.

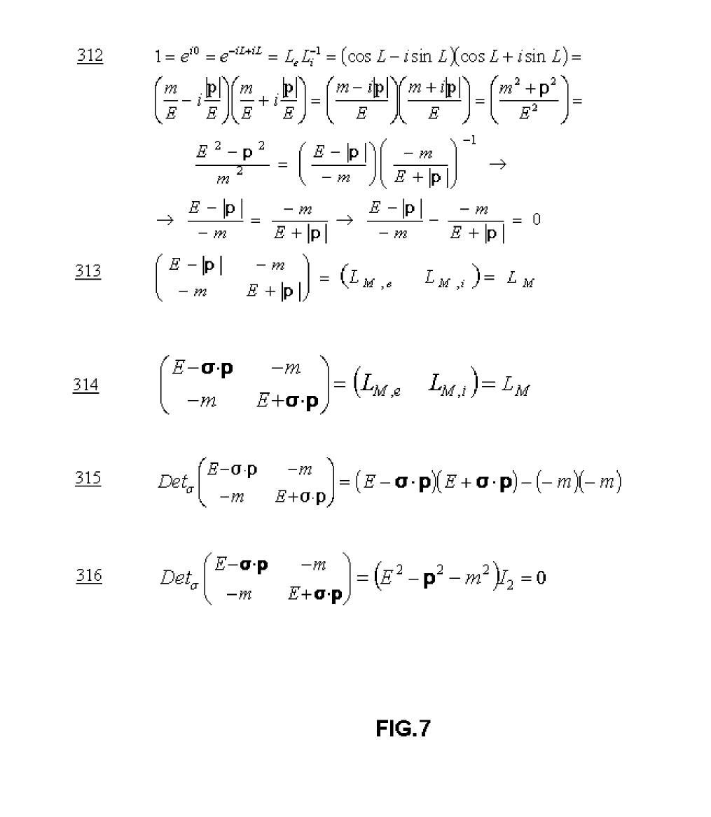

One kind of metamorphosis of expressions 303, 304, 308, 309, 310 is respectively 312, 313, 314, 315, 316. of FIG. 7. Expression 313 is the unspinized Matrix Law in Weyl (chiral) form. Expression 314 is spinized Matrix Law in Weyl (chiral) form.

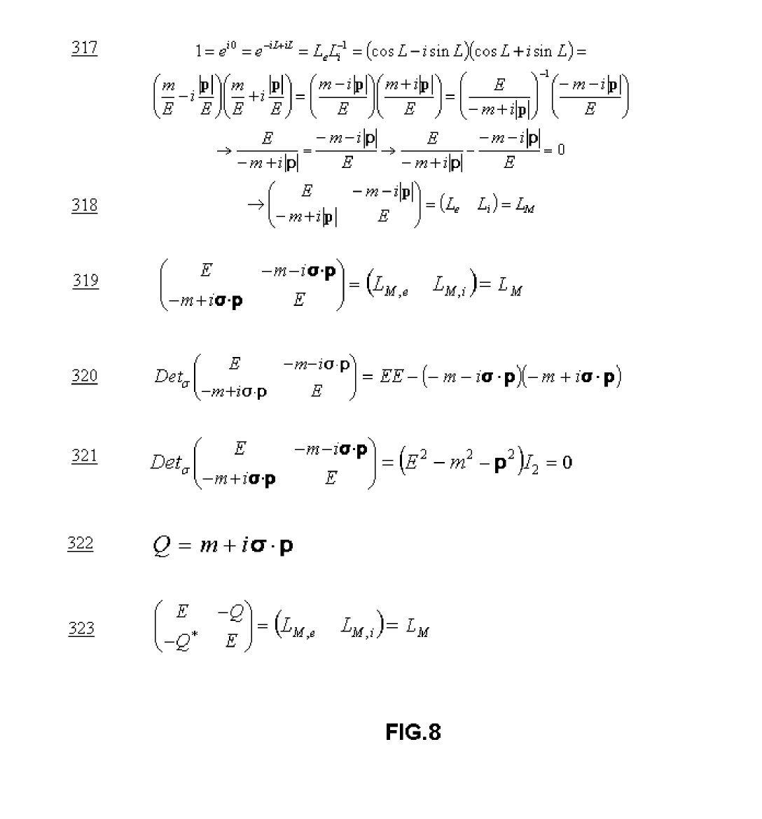

Another kind of metamorphosis of expressions 303, 304, 308, 309, 310 is respectively 317, 318, 319, 320, 321 of FIG. 8. Indeed, 322 is a quaternion so 319 can be written as 313.

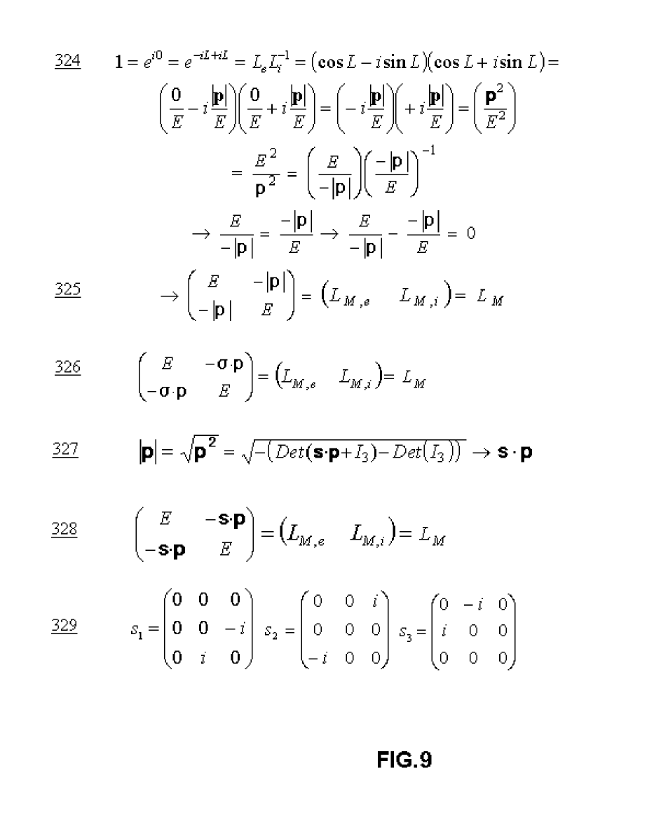

If m=0, expression 303, 304 becomes respectively expression 324, 325 of FIG. 9. After fermionic spinization 306, expression 325 becomes expression 326 which governs massless fermion (neutrino) in Dirac form. After bosonic spinization 327, expression 325 becomes expression 328 where s=(s₁, s₂, s₃) are spin operators for spin 1 particle as shown in expression 329. From definition 330, expression 331 is obtained. To obey fundamental relationship 301 in determinant view 331, it is necessary that the last term in 331 acting on the external and internal wave functions respectively produce null result (zero) in source-free zone. It is proposed that expression 325 governs massless particle with unobservable spin (spinless). After bosonic spinization, the spinless and massless particle gains its spin 1.

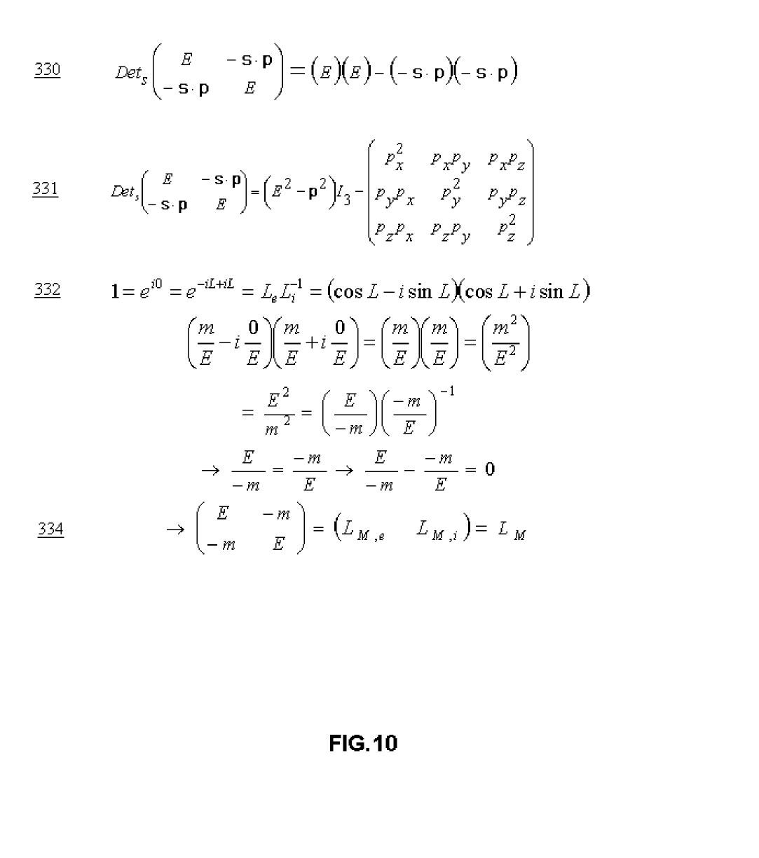

Further, if |p↑=0, expression 303, 304 becomes respectively expression 332, 334 of FIG. 10. It is suggested that the above spaceless forms of matrix rules 332, 334 govern the external and internal wave functions (self-fields) which play the roles of spaceless gravitons, that is, they mediate space (distance) independent interactions through proper time (mass) entanglement.

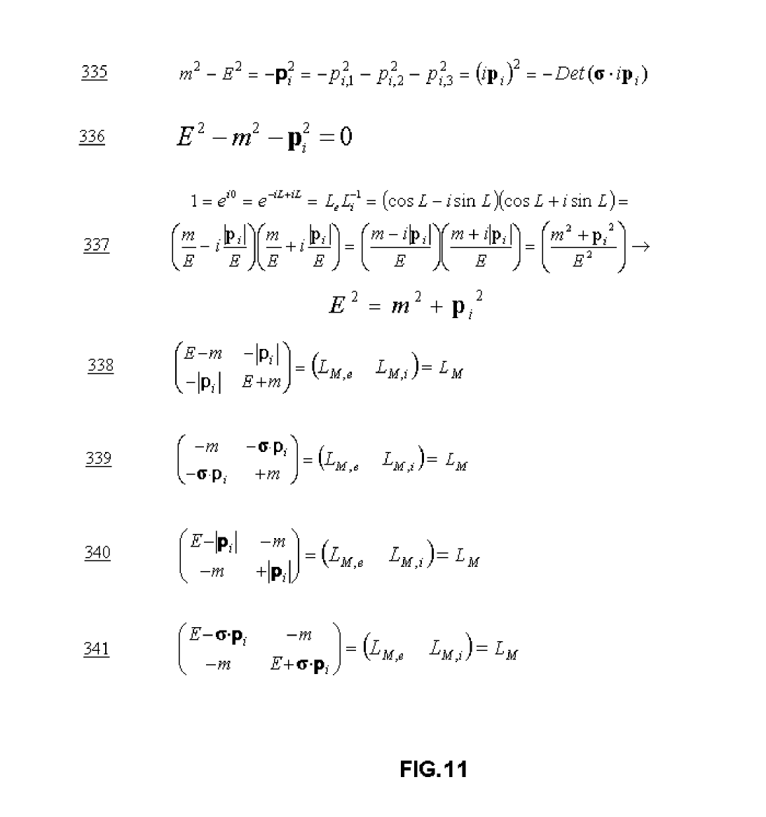

In prespacetime model, self-confinement of an elementary entity is produced through imaginary momentum pᵢ (downward self-reference such that m²>E²) as shown in expression 335 or 336 of FIG. 11 which is created by primordial self-referential spin shown in 337 of FIG. 11. Therefore, allowing imaginary momentum (downward self-reference) for an elementary entity, matrix rules in Dirac-like forms as shown in 338, 339 can be generated through self-referential spin. Indeed, matrix rules in Weyl-like (chiral-like) form as shown in 340, 341 can also be similarly generated. It is proposed that these additional forms of self-referential matrix rules govern proton in Dirac and Weyl form respectively.

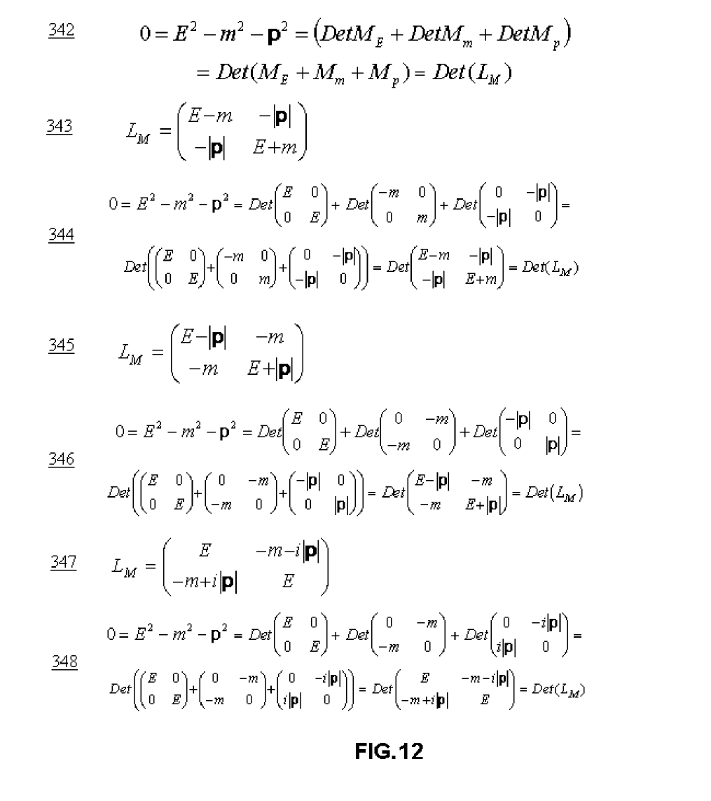

The matrix game for generating various forms of the matrix rules prior to spinization is invented and summarized in express 342 of FIG. 12 where Det means determinant and M_{E}, Mₘ and Mₚ are respectively matrices with ±E (or ±iE), ±m (or ±im) and ±|p| (or ±i|p|) as elements respectively, and E², −m² and −p² as determinant respectively, and L_{M} is the matrix rule so derived. By way of a first example, the matrix rule in Dirac form 343 prior to spinization can be derived as shown in 344. By way of a second example, the matrix rule in Weyl form 345 prior to spinization can be derived as shown in 346. By way of a third example, the matrix rule in quaternion form 347 prior to spinization can be derived as shown in 348.

The Natural laws created in accordance with the prespacetime model are hierarchical and comprised of: (1) immanent Law of Conservation manifesting and governing in the external or internal world which may be violated in certain processes; (2) immanent Law of Zero manifesting and governing in the dual world as a whole; and (3) transcendental Law of One manifesting and governing in prespacetime. By ways of examples, conservations of energy, momentum and mass are immanent (and approximate) laws manifesting and governing in the external or internal world. Conservations of energy, momentums or mass to zero in the dual world comprised of the external world and internal world are immanent law manifesting and governing in the dual world as a whole. Conservation of One (Unity) based on energy-momentum-mass relationship is transcendental law manifesting and governing in prespacetime which is the foundation of external world and internal world.

### III. Generation of Elementary Particles

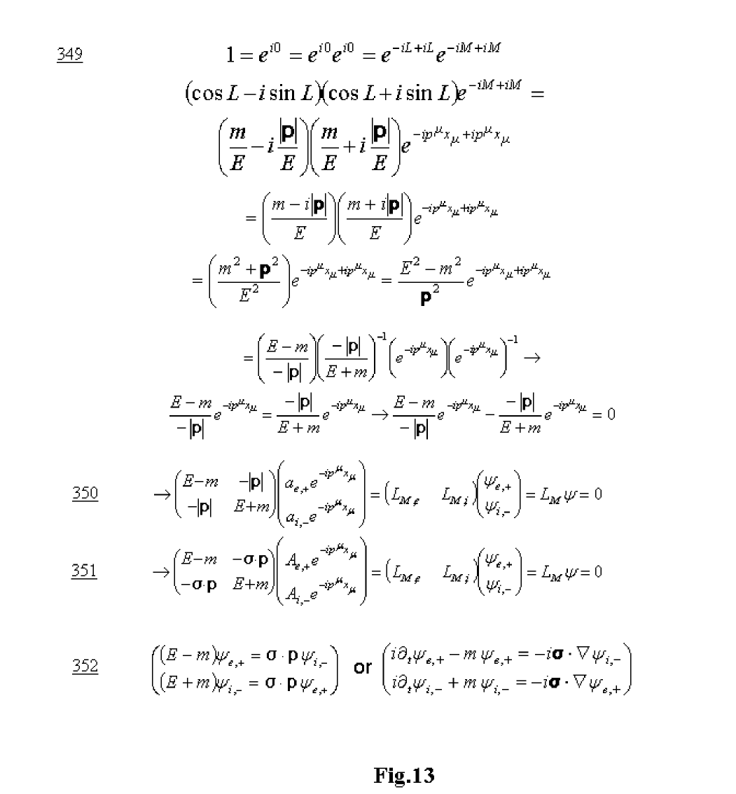

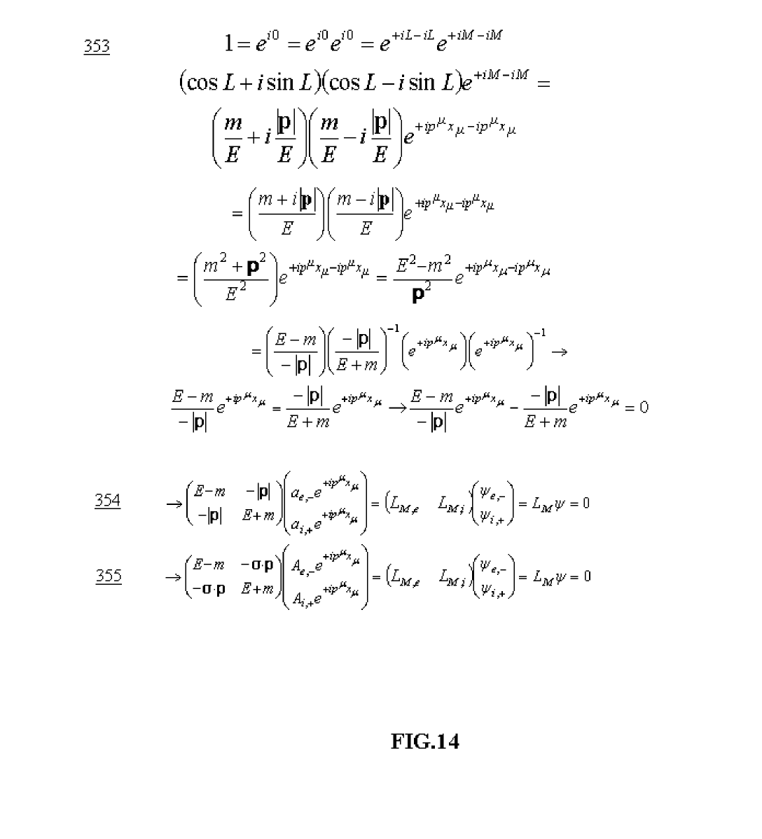

In one embodiment, a free plane-wave fermion such as an electron in Dirac form is created, sustained and made evolving in the prespacetime as shown in mathematical expressions 349, 350, 351 of FIG. 13. A different expression of 351 is shown in 352.

In a 2^{nd} embodiment, a free plane-wave antifermion such as a positron in Dirac form is created, sustained and made evolving in prespacetime as shown mathematical expressions 353, 354 and 355 of FIG. 14.

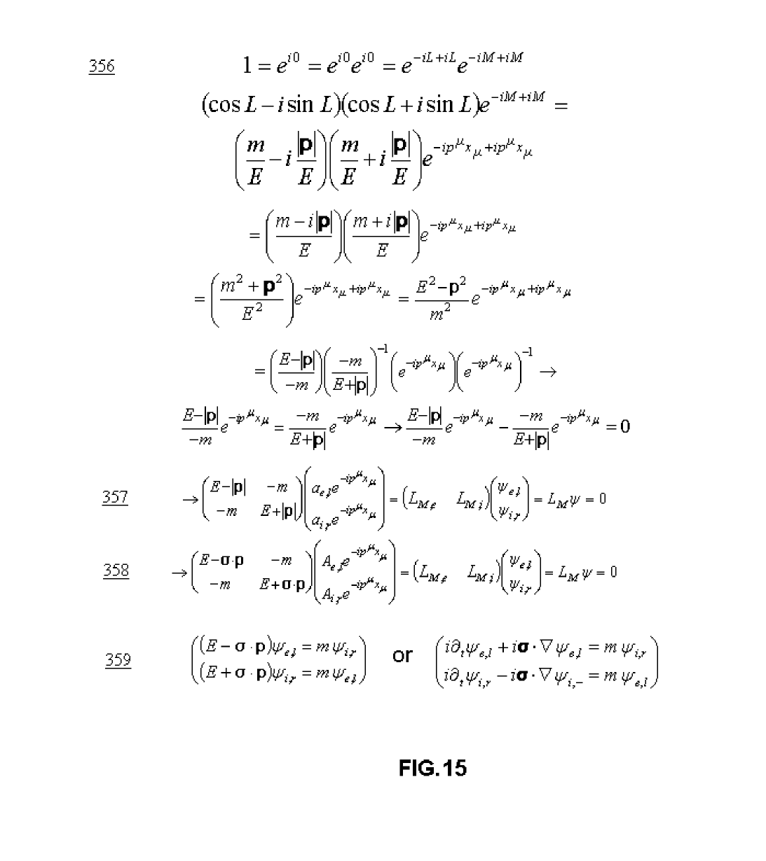

In a 3^{rd} embodiment, a free plane-wave fermion such as an electron in Weyl (chiral) form is created, sustained and made evolving in prespacetime as shown mathematical expressions 356, 357 and 358 of FIG. 15. A different expression of 358 is shown in 359.

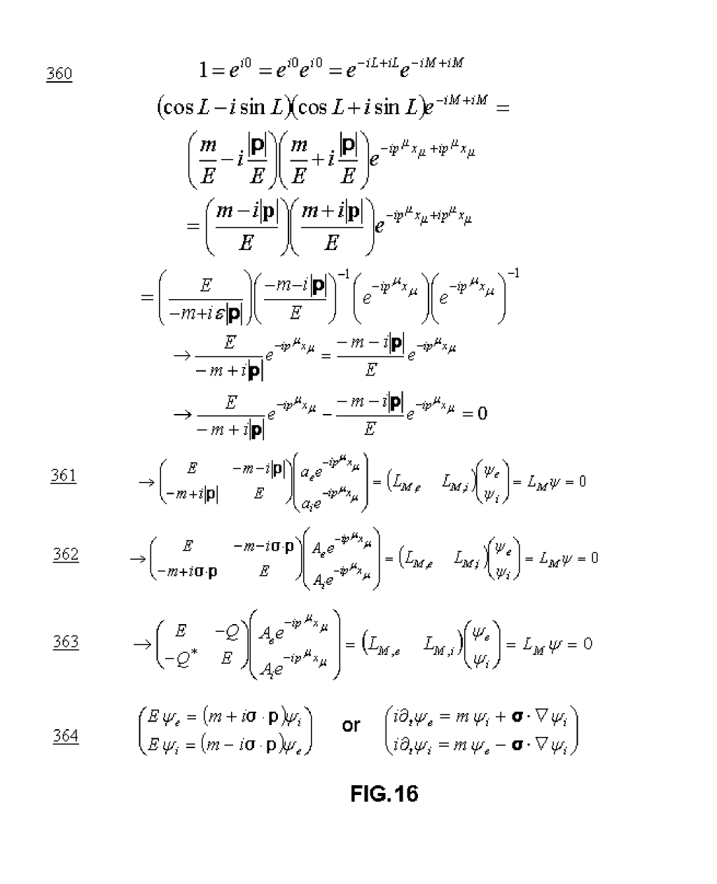

In a 4^{th} embodiment, a free plane-wave fermion such as an electron in a 4^{th} form is created, sustained and made evolving in prespacetime as shown mathematical expressions 360, 361, 362 and 363 of FIG. 16. A different expression of 362 is shown in 364.

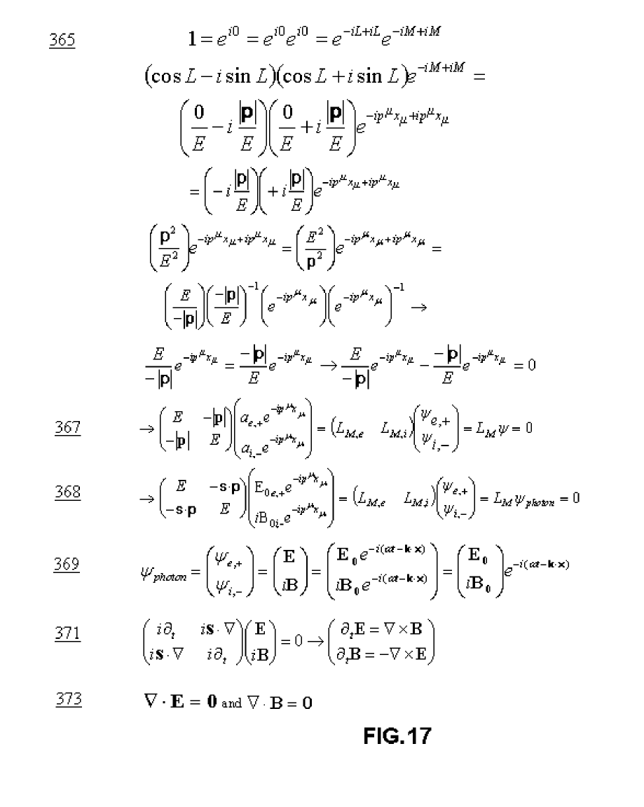

In a 5^{th} embodiment, a linear plane-wave photon is created, sustained and made evolving in prespacetime as shown mathematical expressions 365, 367 and 368 of FIG. 17.

The linear plane-wave photon has a wave function as shown in 369. Two of the Maxwell equations in a vacuum are derived as shown in 371. These two equations together with equations (or source-free conditions) in 373 form a complete set of the Maxwell equations in a source-free zone.

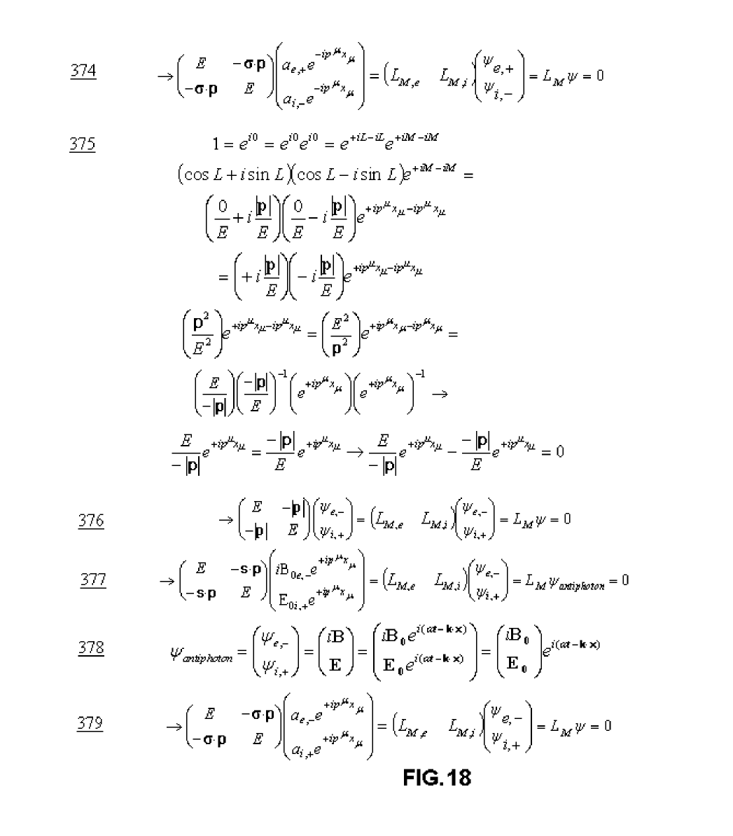

In a 6^{th} embodiment, a free plane-wave massless neutrino in Dirac form is created, sustained and made evolving in prespacetime by replacing the bosonic spinization shown in 368 with the fermionic spinization shown in 374 of FIG. 18.

In a 7^{th} embodiment, a linear plane-wave antiphoton is created, sustained and made evolving in prespacetime as shown in 375, 376 and 377 of FIG. 18. The linear plane-wave antiphoton has a wave function as shown in 378.

In an 8^{th} embodiment, a free plane-wave massless antineutrino in Dirac form is created, sustained and made evolving in prespacetime by replacing the bosonic spinization shown in 377 with the fermionic spinization shown in 379.

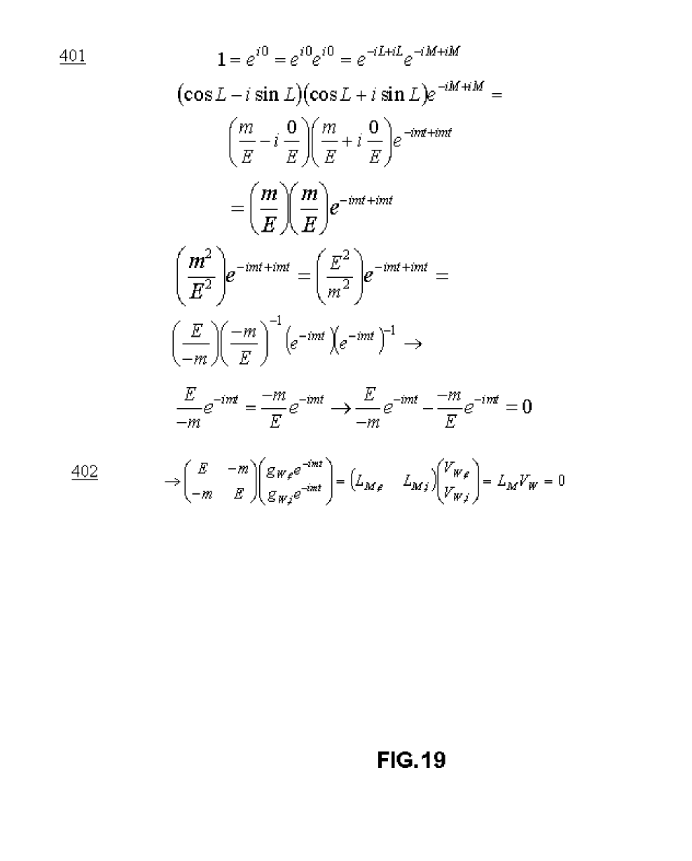

In a 9^{th} embodiment, a spaceless (distance independent) wave function (spaceless graviton) of a mass m in Weyl form is created, sustained and made evolving in prespacetime as shown in mathematical expressions 401 and 402 of FIG. 19.

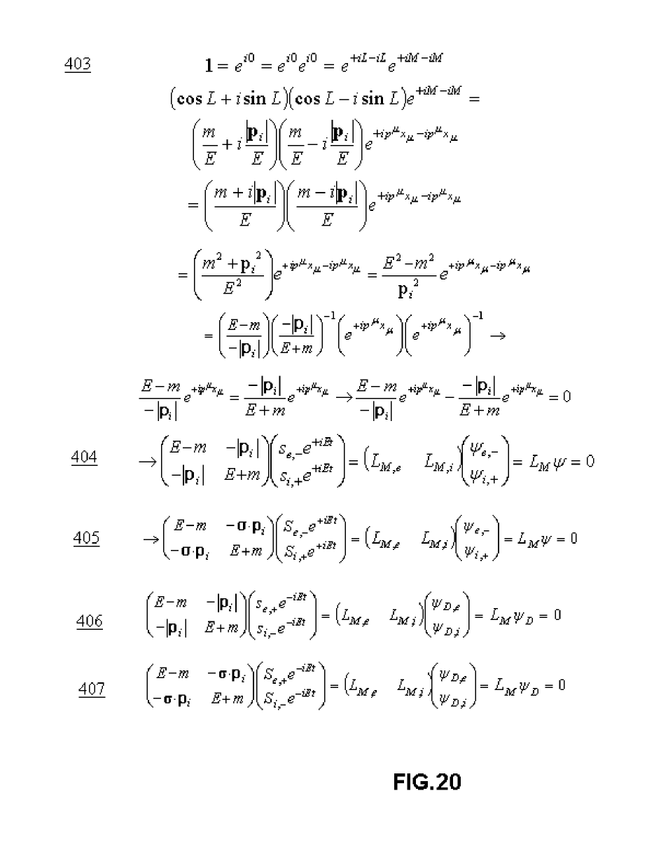

In a 10^{th} embodiment, a spatially self-confined entity such as a proton in Dirac form is created, sustained and made evolving in prespacetime through imaginary momentum pᵢ (downward self-reference) such that m²>E² as shown in mathematical expressions 403, 404 and 405 of FIG. 20. In the prespacetime model, equation 404 governs the spatial self-confinement of an unspinized proton in Dirac form through the imaginary momentum pᵢ and, on the other hand, equation 405 governs the spatial self-confinement of the spinized proton in Dirac form through the imaginary momentum pᵢ.

Thus, according to the prespacetime model, an unspinized antiproton and a spinized antiproton in Dirac form are respectively governed by equation 406 and 407 of FIG. 20.

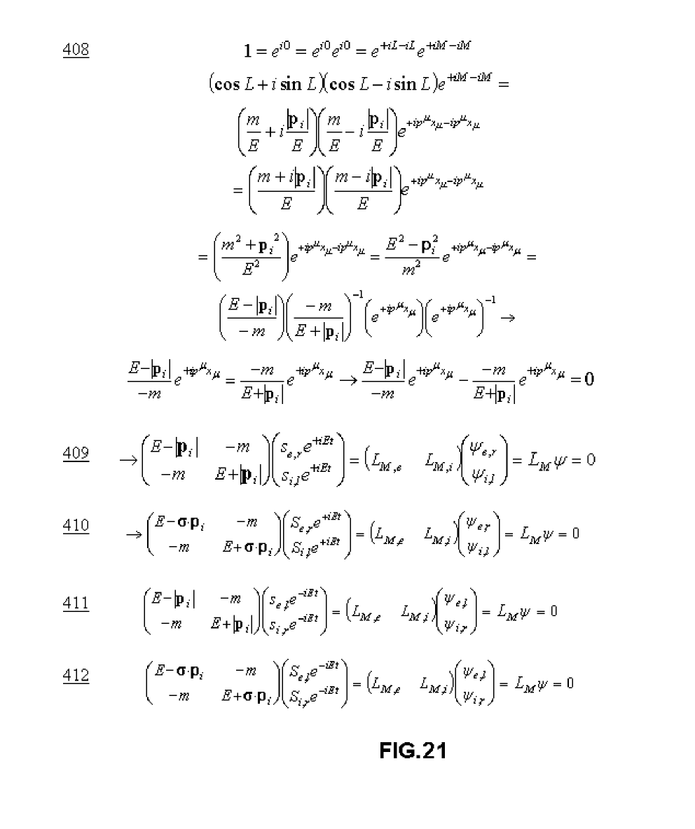

In a 11^{th} embodiment, a spatially self-confined entity such as a proton in Weyl form is created, sustained and made evolving in prespacetime through the imaginary momentum pᵢ (downward self-reference) such that m²>E² as shown in mathematical expressions 408, 409 and 410 of FIG. 21. In the prespacetime model, equation 409 governs the spatial self-confinement of an unspinized proton in Weyl form through the imaginary momentum pᵢ and, on the other hand, equation 410 governs the spatial self-confinement of the spinized proton in Weyl form through the imaginary momentum pᵢ.

Thus, according to the present model, an unspinized antiproton and a spinized antiproton in Weyl form are respectively governed by equation 411 and 412 of FIG. 21.

### IV. Generation of Composite Particles

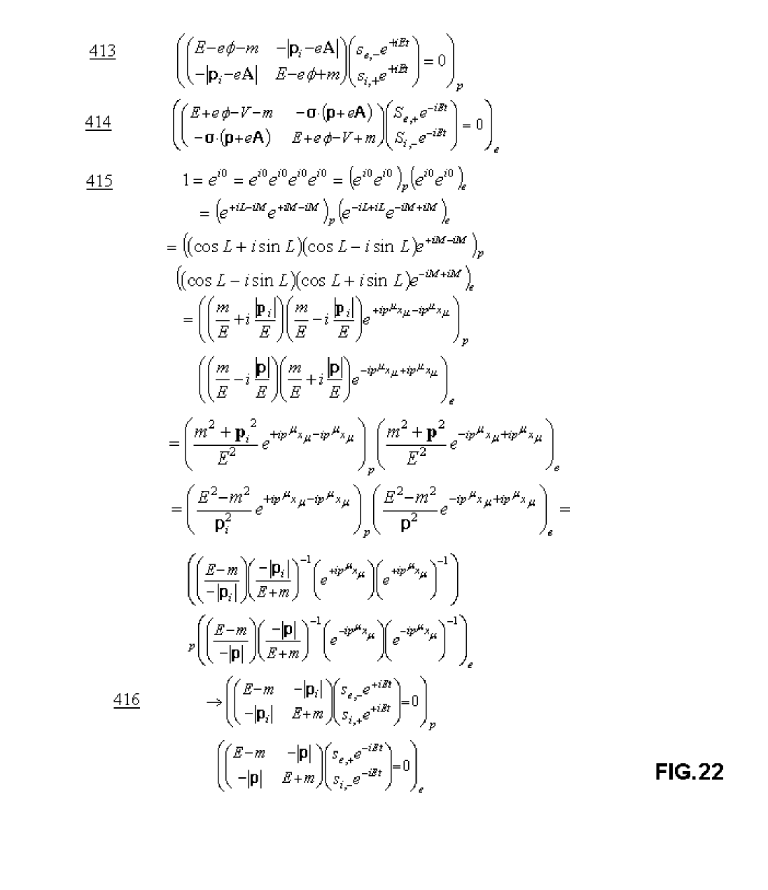

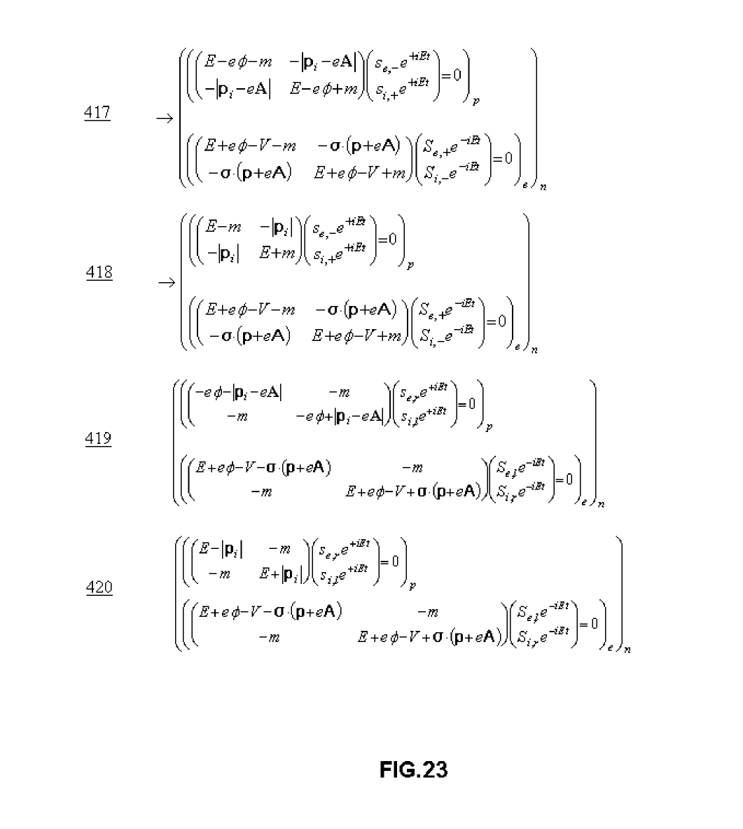

In a first embodiment, a neutron comprised of an unspinized proton in Dirac form shown in 413 of FIG. 22 and a spinized electron in Dirac form shown in 414 of FIG. 22 is created, sustained and made evolving in prespacetime as shown in mathematical expressions 415 and 416 of FIGS. 22 and 417 of FIG. 23 in which ( ), ( ) and ( ) indicate proton, electron and neutron respectively. Further, the unspinized proton has electric charge e, the spinized electron has charge −e; (φ, A)ₚ, (φ, A)ₑ are respectively electromagnetic potential acting on the unspinized proton and the tightly bound spinized electron; and V is a binding potential from the unspinized proton acting on the spinized electron causing tight binding. If (φ, A)ₚ is negligible due to fast motion of the tightly bound spinized electron, 418 is derived from 417. Experimental data on charge distribution and g-factor of the neutron support the neutron in the prespacetime model which is comprised of the unspinized proton and the tightly bound spinized electron. A Weyl form of 417 and 418 are respectively 419 and 420 of FIG. 23.

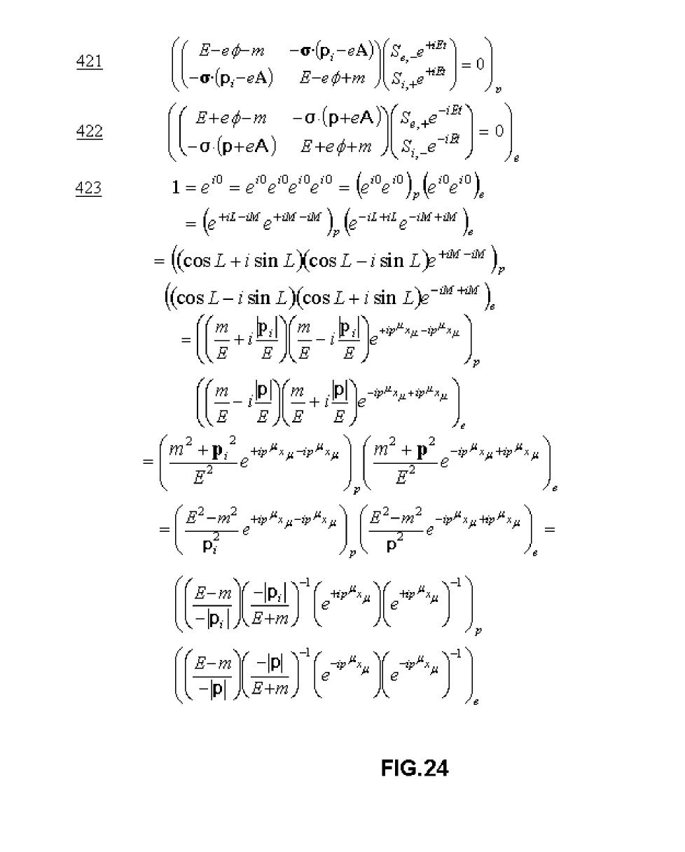

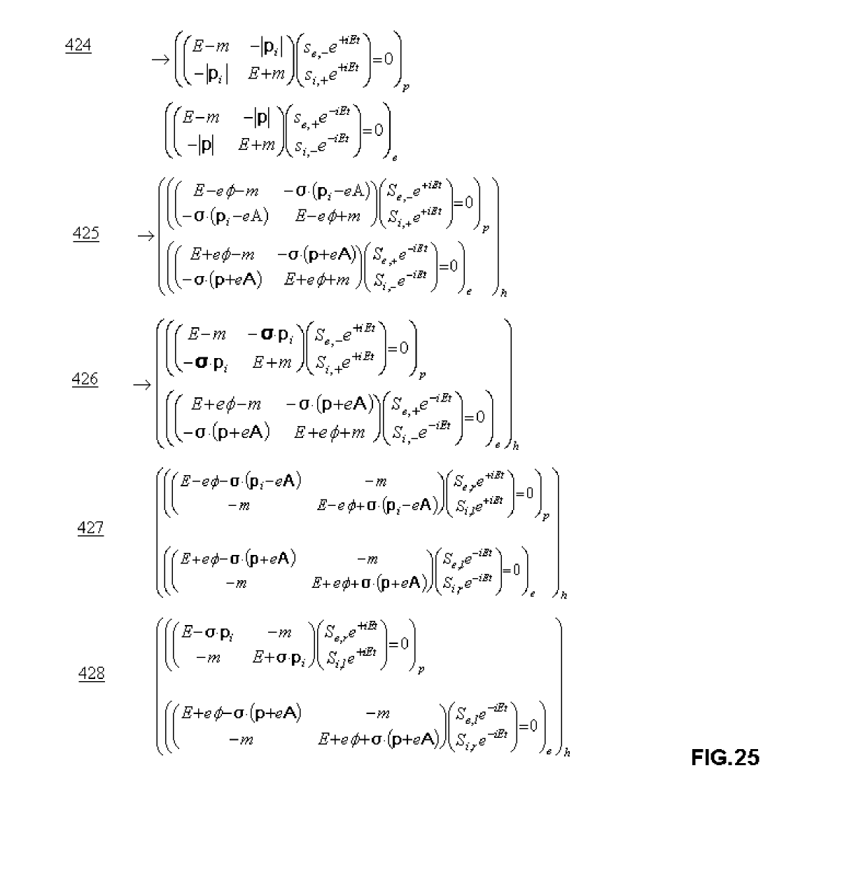

In a second embodiment, hydrogen comprised of a spinized proton in Dirac form shown in 421 of FIG. 24 and a spinized electron in Dirac form shown in 422 of FIG. 24 is created, sustained and made evolving in prespacetime as shown in mathematical expressions 423 of FIGS. 24 and 424 and 425 of FIG. 25. In FIGS. 24 & 25, ( )ₚ, ( )ₑ and ( )ₕ indicate proton, electron and hydrogen respectively. Further, the spinized proton has electric charge e, the spinized electron has charge −e; and (φ, A)ₚ, (φ, A)ₑ are respectively electromagnetic potential acting on the spinized proton and the spinized electron in FIG. 25. If (φ, A)ₚ is negligible due to fast motion of the spinized electron in FIG. 25, 426 is derived from 425. A Weyl form of 425 and 426 are respectively 427 and 428 of FIG. 25.

### V. Prespacetime Model of Ether (Aeher)

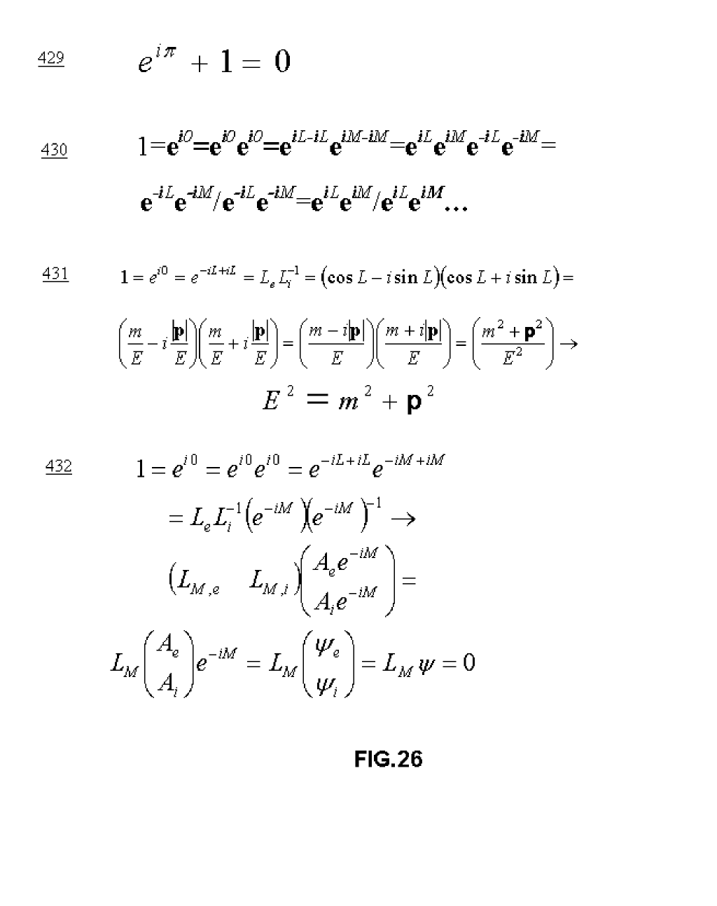

In the prespacetime model, the mathematical representation of the primordial ether in prespacetime is the Euler's number (Euler's Constant) e which makes the Euler's identity 429 of FIG. 26 to hold. Second, in the prespacetime model the Euler's number e is the foundation of primordial distinctions shown in 430 of FIG. 26. Third, in the prespacetime model the Euler's number e is the foundation for generating the energy-momentum-mass relationship as shown 431 of FIG. 26. Fourth, in the prespacetime model the Euler's number e is the foundation for creating, sustaining and making evolving the elementary particle as shown 432 of FIG. 26.

Further, in the prespacetime model, Euler's number e is the foundation of quantum entanglement or gravity in prespacetime.

It will be evident from the above that there are other embodiments which are clearly within the scope and spirit of the present invention, although they were not expressly set forth above. Therefore, the above disclosure is exemplary only, and the actual scope of my invention is to be determined by the claims.

What is claimed is:

1: A method for presenting and/or modeling generation of an energy-momentum-mass relationship of an elementary particle, as a research aide, teaching tool and/or game, comprising the steps of:
generating a first representation which comprises:
$$1 = {e}^{i 0} = {e}^{- i L + i L} = ( cos L - i sin L ) ( cos L + i sin L ) = ( \frac{m}{E} - i \frac{\vert p \vert}{E} ) ( \frac{m}{E} + i \frac{\vert p \vert}{E} ) = ( \frac{{m}^{2} + {p}^{2}}{{E}^{2}} ) \to {E}^{2} = {m}^{2} + {p}^{2}$$
where e is natural exponential base, i is imaginary unit, L is a phase, E, m and p represent respectively energy, mass and momentum of said elementary particle, and speed of light c is set equal to one; and
presenting and/or modeling said first representation in a device for research, teaching and/or game.

2: A method as in claim 1 wherein said first representation is modified to include an electromagnetic potential (A,φ) generated by a second elementary particle, said modified representation comprising:
$$1 = {e}^{i 0} = {e}^{- i L + i L} = ( cos L - i sin L ) ( cos L + i sin L ) = ( \frac{m}{E - e φ} - i \frac{\vert p - eA \vert}{E - e φ} ) ( \frac{m}{E - e φ} + i \frac{\vert p - eA \vert}{E - e φ} ) = ( \frac{{m}^{2} + {\vert p - eA \vert}^{2}}{{( E - e φ )}^{2}} ) \to {( E - e φ )}^{2} = {m}^{2} + {( p - eA )}^{2}$$
where e next to φ or A is electric charge of said elementary particle.

3: A method as in claim 1 for presenting and/or modeling generation of a self-referential matrix rule further comprising the steps of:
generating a second representation which comprises:
$$\to 1 = \frac{{E}^{2} - {m}^{2}}{{p}^{2}} = ( \frac{E - m}{- \vert p \vert} ) {( \frac{- \vert p \vert}{E + m} )}^{- 1} \to \frac{E - m}{- \vert p \vert} = \frac{- \vert p \vert}{E + m} \to \frac{E - m}{- \vert p \vert} - \frac{- \vert p \vert}{E + m} = 0 \\ \to ( \begin{matrix}E - m & - \vert p \vert \\ - \vert p \vert & E + m\end{matrix} ) \to ( \begin{matrix}E - m & - σ \cdot p \\ - σ \cdot p & E + m\end{matrix} ) or ( \begin{matrix}E - m & - s \cdot p \\ - s \cdot p & E + m\end{matrix} ) , \\ \to 1 = \frac{{E}^{2} - {p}^{2}}{{m}^{2}} = ( \frac{E - \vert p \vert}{- m} ) {( \frac{- m}{E + \vert p \vert} )}^{- 1} \to \frac{E - \vert p \vert}{- m} = \frac{- m}{E + \vert p \vert} \to \frac{E - \vert p \vert}{- m} - \frac{- m}{E + \vert p \vert} = 0 \\ \to ( \begin{matrix}E - \vert p \vert & - m \\ - m & E + \vert p \vert\end{matrix} ) \to ( \begin{matrix}E - σ \cdot p & - m \\ - m & E + σ \cdot p\end{matrix} ) or ( \begin{matrix}E - s \cdot p & - m \\ - m & E + s \cdot p\end{matrix} ) , \\ \to 1 = \frac{{m}^{2} + {p}^{2}}{{E}^{2}} = {( \frac{E}{- m + i \vert p \vert} )}^{- 1} ( \frac{- m - i \vert p \vert}{E} ) \\ \to \frac{E}{- m + i \vert p \vert} = \frac{- m - i \vert p \vert}{E} \to \frac{E}{- m + i \vert p \vert} - \frac{- m - i \vert p \vert}{E} = 0 \\ \to ( \begin{matrix}E & - m - i \vert p \vert \\ - m + i \vert p \vert & E\end{matrix} ) \to ( \begin{matrix}E & - m + i σ \cdot p \\ - m + i σ \cdot p & E\end{matrix} ) or ( \begin{matrix}E & - m + is \cdot p \\ - m + is \cdot p & E\end{matrix} ) , or \\ \to 1 = \frac{{E}^{2} - {p}_{i}^{2}}{{m}^{2}} = ( \frac{E - \vert {p}_{i} \vert}{- m} ) {( \frac{- m}{E + \vert {p}_{i} \vert} )}^{- 1} \to \frac{E - \vert {p}_{i} \vert}{- m} = \frac{- m}{E + \vert {p}_{i} \vert} \to \frac{E - \vert {p}_{i} \vert}{- m} - \frac{- m}{E + \vert {p}_{i} \vert} = 0 \\ \to ( \begin{matrix}E - \vert {p}_{i} \vert & - m \\ - m & E + \vert {p}_{i} \vert\end{matrix} ) \to ( \begin{matrix}E - σ \cdot {p}_{i} & - m \\ - m & E + σ \cdot {p}_{i}\end{matrix} ) or ( \begin{matrix}E - s \cdot {p}_{i} & - m \\ - m & E + s \cdot {p}_{i}\end{matrix} ) ,$$
where σ=(σ₁, σ₂, σ₃) are Pauli matrices, |p|=\sqrt{p²}=\sqrt{−Det(σ·p)}→σ·p represents fermionic spinization of |p|, s=(s₁, s₂, s₃) are spin operators for spin 1 particle, |p|=\sqrt{p²}={square root over (−(Det(s·p+I₃)−Det(I₃)))}→s·p represents bosonic spinization of |p|,pᵢ represents imaginary momentum, |pᵢ|=\sqrt{pᵢ²}=\sqrt{−Det(σ·pᵢ)}→σ·pᵢ represents fermionic spinization of |pᵢ|, and |pᵢ|=\sqrt{pᵢ²}={square root over (−(Det(s·pᵢ+I₃)−Det(I₃)))}→s·Pᵢ represents bosonic spinization of |pᵢ|;
presenting and/or modeling said second representation in said device for research, teaching and/or game.

4: A method for presenting and/or modeling generation, sustenance and evolution of an elementary particle, as a research aide, teaching tool and/or game, comprising the steps of:
generating a first representation of said generation, sustenance and evolution of said elementary particle, said first representation comprising:
$$1 = {e}^{i 0} = {e}^{i 0} {e}^{i 0} = {e}^{- i L + i L} {e}^{- i M + i M} = {L}_{e} {L}_{i}^{- 1} ( {e}^{- i M} ) {( {e}^{- i M} )}^{- 1} \to ( {L}_{M , e} {L}_{M , i} ) ( \begin{matrix}{A}_{e} {e}^{- i M} \\ {A}_{i} {e}^{- i M}\end{matrix} ) = {L}_{M} ( \begin{matrix}{ψ}_{e} \\ {ψ}_{i}\end{matrix} ) = 0$$
where e is natural exponential base, i is imaginary unit, L is a first phase, M is a second phase, Aₑe^{-iM}=ψₑ represents external object, Aᵢe^{-iM}=ψᵢ represents internal object, Lₑ represents external rule, Lᵢ represents internal rule, L=(L_{M,e} L_{M,i}) represents matrix rule, L_{M,e} represents external matrix rule and L_{M,i} represents internal matrix rule; and
presenting and/or modeling said first representation in a device for research, teaching and/or game.

5: A method as in claim 4 wherein said external object comprises of an external wave function; said internal object comprises of an internal wave function; said elementary particle comprises of a fermion, boson or unspinized particle; said matrix rule containing an energy operator E→i∂ₜ, momentum operator p→−i∇, spin operator σ where σ=(σ₁, σ₂, σ₃) are Pauli matrices, spin operator S where S=(s₁, s₂, s₃) are spin 1 matrices, and/or mass; said matrix rule further having a determinant containing E²−p²−m²=0, E²−p²=0, E²−m²=0, or 0²−p²−m²=0; c=1 where cis speed of light; and [symbol] =1 where [symbol] is reduced Planck constant.

6: A method as in claim 5 wherein first representation of said generation, sustenance and evolution of said elementary particle comprises:
$$1 = {e}^{i 0} = {e}^{i 0} {e}^{i 0} = {e}^{+ i L - i L} {e}^{+ i M - i M} = ( cos L + i sin L ) ( cos L - i sin L ) {e}^{+ i M - i M} = ( \frac{m}{E} + i \frac{\vert p \vert}{E} ) ( \frac{m}{E} - i \frac{\vert p \vert}{E} ) {e}^{+ i {p}^{μ} {x}_{μ} - i {p}^{μ} {x}_{μ}} = ( \frac{{m}^{2} + {p}^{2}}{{E}^{2}} ) {e}^{+ i {p}^{μ} {x}_{μ} - i {p}^{μ} {x}_{μ}} = \frac{{E}^{2} - {m}^{2}}{{p}^{2}} {e}^{+ i {p}^{μ} {x}_{μ} - i {p}^{μ} {x}_{μ}} = ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} \to \frac{E - m}{- \vert p \vert} {e}^{- i {p}^{μ} {x}_{μ}} = \frac{- \vert p \vert}{E + m} {e}^{- i {p}^{μ} {x}_{μ}} \to \frac{E - m}{- \vert p \vert} {e}^{- i {p}^{μ} {x}_{μ}} - \frac{- \vert p \vert}{E + m} {e}^{- i {p}^{μ} {x}_{μ}} = 0 \to ( \begin{matrix}E - m & - \vert p \vert \\ - \vert p \vert & E + m\end{matrix} ) ( \begin{matrix}{a}_{e , +} {e}^{- i {p}^{μ} {x}_{μ}} \\ {a}_{i , -} {e}^{- i {p}^{μ} {x}_{μ}}\end{matrix} ) = 0 \\ \to ( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( {L}_{M , e} {L}_{M , i} ) ( \begin{matrix}{ψ}_{e , +} \\ {ψ}_{i , -}\end{matrix} ) = 0 or \\ ( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( {L}_{M , e} {L}_{M , i} ) ( \begin{matrix}{ψ}_{e , +} \\ {ψ}_{i , -}\end{matrix} ) = 0$$
where
$$( \begin{matrix}E - m & - \vert p \vert \\ - \vert p \vert & E + m\end{matrix} ) ( \begin{matrix}{a}_{e , +} {e}^{- i {p}^{μ} {x}_{μ}} \\ {a}_{i , -} {e}^{- i {p}^{μ} {x}_{μ}}\end{matrix} ) = 0$$
is a first equation for said unspinized particle,
$$( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0$$
is Dirac equation in Dirac form for said fermion, and
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0$$
is a first equation for said boson;
$$\begin{matrix}1 = {e}^{i 0} \\ = {e}^{i 0} {e}^{i 0} \\ = {e}^{+ iL - iL} {e}^{+ iM - iM} \\ = ( cos L + i sin L ) ( cos L - i sin L ) {e}^{+ iM - iM} \\ = ( \frac{m}{E} + i \frac{\vert p \vert}{E} ) ( \frac{m}{E} - i \frac{\vert p \vert}{E} ) {e}^{+ i {p}^{μ} {x}_{μ} - i {p}^{μ} {x}_{μ}} \\ = ( \frac{{m}^{2} + {p}^{2}}{{E}^{2}} ) {e}^{i {p}^{μ} {x}_{μ} - i {p}^{μ} {x}_{μ}} \\ = \frac{{E}^{2} - {p}^{2}}{{m}^{2}} {e}^{+ i {p}^{μ} {x}_{μ} - i {p}^{μ} {x}_{μ}} \\ = ( \frac{E - \vert p \vert}{- m} ) {( \frac{- m}{E + \vert p \vert} )}^{- 1} ( {e}^{+ i {p}^{μ} {x}_{μ}} ) {( {e}^{+ i {p}^{μ} {x}_{μ}} )}^{- 1} -> \frac{E - \vert p \vert}{- m} {e}^{i {p}^{μ} {x}_{μ}} \\ = \frac{- m}{E + \vert p \vert} {e}^{+ i {p}^{μ} {x}_{μ}} -> \frac{E - \vert p \vert}{- m} {e}^{- i {p}^{μ} {x}_{μ}} \\ = 0 -> ( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) \\ = 0 -> ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) \\ = ( {L}_{M , e} {L}_{M , i} ) ( \begin{matrix}{ψ}_{e , l} \\ {ψ}_{i , r}\end{matrix} ) = 0 or \\ ( \begin{matrix}E - s \cdot p & - m \\ - m & E + \vert p \vert\end{matrix} ) ( \begin{matrix}{A}_{e , l} {e}^{- i {p}^{μ} {x}_{μ}} \\ {A}_{i , r} {e}^{- {ip}^{μ} {x}_{μ}}\end{matrix} ) \\ = ( {L}_{M , e} {L}_{M , i} ) ( \begin{matrix}{ψ}_{e , l} \\ {ψ}_{i , r}\end{matrix} ) = 0\end{matrix}$$
where
$$( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) = 0$$
is a second equation for said unspinized particle,
$$( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
is Dirac equation in Weyl form for said fermion, and
$$( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
is a second equation for said boson;
$$\begin{matrix}1 = {e}^{i 0} \\ = {e}^{i 0} {e}^{i 0} \\ = {e}^{+ iL - iL} {e}^{+ iM - iM} \\ = ( cos L + i sin L ) ( cos L - i sin L ) {e}^{+ iM - iM} \\ = ( \frac{m}{E} + i \frac{\vert p \vert}{E} ) ( \frac{m}{E} - i \frac{\vert p \vert}{E} ) {e}^{+ i {p}^{μ} {x}_{μ} - i {p}^{μ} {x}_{μ}} \\ = ( \frac{E}{- m + i \vert p \vert} ) {( \frac{- m - i \vert p \vert}{E} )}^{- 1} ( {e}^{- i {p}^{μ} {x}_{μ}} ) {( {e}^{- i {p}^{μ} {x}_{μ}} )}^{- 1} -> \\ \frac{E}{- m + i \vert p \vert} {e}^{- i {p}^{μ} {x}_{μ}} \\ = \frac{- m - i \vert p \vert}{E} {e}^{- i {p}^{μ} {x}_{μ}} -> \frac{E}{- m + i \vert p \vert} {e}^{- i {p}^{μ} {x}_{μ}} - \frac{- m - i \vert p \vert}{E} {e}^{- i {p}^{μ} {x}_{μ}} = 0 \\ -> ( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0 \\ -> ( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = ( {L}_{M , e} {L}_{M , i} ) ( \begin{matrix}{ψ}_{e} \\ {ψ}_{i}\end{matrix} ) = 0 \\ or \\ ( \begin{matrix}E & - m - is \cdot p \\ - m + is \cdot p & E\end{matrix} ) ( \begin{matrix}{A}_{e} {e}^{- {ip}^{μ} {x}_{μ}} \\ {A}_{i} {e}^{- {ip}^{μ} {x}_{μ}}\end{matrix} ) = ( {L}_{M , e} {L}_{M , i} ) ( \begin{matrix}{ψ}_{e} \\ {ψ}_{i}\end{matrix} ) = 0\end{matrix}$$
where
$$( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0$$
is a third equation for said unspinized particle,
$$( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is Dirac equation in a third form for said fermion, and
$$( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is a third equation for said boson; or
$$\begin{matrix}1 = {e}^{i 0} \\ = {e}^{i 0} {e}^{i 0} \\ = {e}^{+ iL - iL} {e}^{+ iM - iM} \\ = ( cos L + i sin L ) ( cos L - i sin L ) {e}^{+ iM - iM} \\ = ( \frac{m}{E} + i \frac{\vert {p}_{i} \vert}{E} ) ( \frac{m}{E} - i \frac{\vert {p}_{i} \vert}{E} ) {e}^{+ i {p}^{μ} {x}_{μ} - i {p}^{μ} {x}_{μ}} \\ = ( \frac{{m}^{2} + {p}_{i}^{2}}{{E}^{2}} ) {e}^{+ i {p}^{μ} {x}_{μ} - i {p}^{μ} {x}_{μ}} \\ = \frac{{E}^{2} - {m}^{2}}{{p}_{i}^{2}} {e}^{+ i {p}^{μ} {x}_{μ} - i {p}^{μ} {x}_{μ}} \\ = ( \frac{E - m}{- \vert {p}_{i} \vert} ) {( \frac{- \vert {p}_{i} \vert}{E + m} )}^{- 1} ( {e}^{{ip}^{μ} {x}_{μ}} ) {( {e}^{- {ip}^{μ} {x}_{μ}} )}^{- 1} \to \\ \frac{E - m}{- \vert {p}_{i} \vert} {e}^{- i {p}^{μ} {x}_{μ}} = \frac{- \vert {p}_{i} \vert}{E + m} {e}^{- i {p}^{μ} {x}_{μ}} \to \\ \frac{E - m}{- {p}_{i}} {e}^{- i {p}^{μ} {x}_{μ}} = \frac{- \vert {p}_{i} \vert}{E + m} {e}^{- i {p}^{μ} {x}_{μ}} = 0 \to \\ ( \begin{matrix}E - m & - \vert {p}_{i} \vert \\ - \vert {p}_{i } \vert & E + m\end{matrix} ) ( \begin{matrix}{s}_{e , +} {e}^{- i Et} \\ {s}_{i , -} {e}^{- i Et}\end{matrix} ) = 0 -> \\ ( \begin{matrix}E - m & - σ \cdot {p}_{i} \\ - σ \cdot {p}_{i} & E + m\end{matrix} ) ( \begin{matrix}{S}_{e , +} {e}^{- i E t} \\ {S}_{i , -} {e}^{- i Et}\end{matrix} ) \\ = ( {L}_{M , e} {L}_{M , i} ) ( \begin{matrix}{ψ}_{e , +} \\ ψ\end{matrix} ) \\ or \\ ( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = ( {L}_{M , e} {L}_{M , i} ) ( \begin{matrix}{ψ}_{e , +} \\ {ψ}_{i , -}\end{matrix} ) \\ = 0\end{matrix}$$
where
$$( \begin{matrix}E - m & - \vert {p}_{i} \vert \\ - \vert {p}_{i} \vert & E + m\end{matrix} ) ( \begin{matrix}{s}_{e , +} {e}^{- i Et} \\ {s}_{i , -} {e}^{- i Et}\end{matrix} ) = 0$$
is a first equation for said unspinized particle with said imaginary momentum
$${p}_{i} , ( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is Dirac equation in Dirac form for said fermion with said imaginary momentum pᵢ, and
$$( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is a first equation for said boson with said imaginary momentum pᵢ.

7: A method as in claim 6 wherein said elementary particle comprises of:
an electron, equation of said electron being modeled as:
$$( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a positron, equation of said positron being modeled as:
$$( \begin{matrix}E - m & - σ \cdot p \\ - σ \cdot p & E + m\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0$$
$$or \\ ( \begin{matrix}E & - m - i σ \cdot p \\ - m + i σ \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massless neutrino, equation of said neutrino being modeled as:
$$( \begin{matrix}E & - σ \cdot p \\ - σ \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & \\ & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - i σ \cdot p \\ + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
A massless antineutrino, equation of said antineutrino being modeled as:
$$( \begin{matrix}E & - σ \cdot p \\ - σ \cdot p & E\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - σ \cdot p & \\ & E + σ \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0$$
$$or \\ ( \begin{matrix}E & - i σ \cdot p \\ + i σ \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massive spin 1 boson, equation of said massive spin 1 boson being modeled as:
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a massive spin 1 antiboson, equation of said massive spin 1 antiboson being modeled as:
$$( \begin{matrix}E - m & - s \cdot p \\ - s \cdot p & E + m\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0$$
$$or \\ ( \begin{matrix}E & - m - i s \cdot p \\ - m + i s \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massless spin 1 boson, equation of said massless spin 1 boson being modeled as:
$$( \begin{matrix}E & - s \cdot p \\ - s \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( \begin{matrix}E & - s \cdot p \\ - s \cdot p & E\end{matrix} ) ( \begin{matrix}E \\ i B\end{matrix} ) 0 , \\ ( \begin{matrix}E - s \cdot p & \\ & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - i s \cdot p \\ + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
where
$$( \begin{matrix}E & - s \cdot p \\ - s \cdot p & E\end{matrix} ) ( \begin{matrix}E \\ i B\end{matrix} ) = 0$$
is equivalent to Maxwell equation
$$( \begin{matrix}{\partial }_{t} E = ∇ \times B \\ {\partial }_{t} B = - ∇ \times E\end{matrix} ) ;$$
a massless spin 1 antiboson, equation of said massless spin 1 antiboson being modeled as:
$$( \begin{matrix}E & - s \cdot p \\ - s \cdot p & E\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - s \cdot p & \\ & E + s \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0$$
$$or \\ ( \begin{matrix}E & - i s \cdot p \\ - m + i s \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
an antiproton, equation of said antiproton being modeled as:
$$( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , l} {e}^{- i Et} \\ {S}_{i , r} {e}^{- i Et}\end{matrix} ) = 0$$
$$or \\ ( \begin{matrix}E & - m - i σ \cdot {p}_{i} \\ - m + i σ \cdot {p}_{i} & E\end{matrix} ) ( \begin{matrix}{S}_{e} {e}^{- i Et} \\ {S}_{i} {e}^{- i Et}\end{matrix} ) = 0 ; or$$
a proton, equation of said proton being modeled as:
$$( \begin{matrix}E - m & - σ \cdot {p}_{i} \\ - σ \cdot {p}_{i} & E + m\end{matrix} ) ( \begin{matrix}{S}_{e , -} {e}^{+ i Et} \\ {S}_{i , +} {e}^{+ i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , r} {e}^{+ i Et} \\ {S}_{i , l} {e}^{+ i Et}\end{matrix} ) = 0$$
$$or \\ ( \begin{matrix}E & - m - i σ \cdot {p}_{i} \\ - m + i σ \cdot {p}_{i} & E\end{matrix} ) ( \begin{matrix}{S}_{e} {e}^{+ i Et} \\ {S}_{i} {e}^{+ i Et}\end{matrix} ) = 0.$$

8: A method as in claim 6 wherein said elementary particle comprises an electron and said first representation is modified to include a proton, said proton being modeled as a second elementary particle, and interaction fields of said electron and said proton, said modified first representation comprising:
$$\begin{matrix}1 = {e}^{i 0} \\ = {e}^{i 0} {e}^{i 0} {e}^{i 0} {e}^{i 0} \\ = {( {e}^{i 0} {e}^{i 0} )}_{p} {( {e}^{i 0} {e}^{i 0} )}_{e} \\ = {( {e}^{+ iL - iM} {e}^{+ iM - iM} )}_{p} {( {e}^{- iL + iL} {e}^{- iM + iM} )}_{e} \\ = {( ( cos L + i sin L ) ( cos L - i sin L ) {e}^{+ iM - iM} )}_{p} ( ( cos L - i sin L ) ( cos L + i sin L ) \\ { {e}^{- iM + iM} )}_{e} \\ = {( ( \frac{m}{E} + i \frac{\vert {p}_{i} \vert}{E} ) ( \frac{m}{E} - i \frac{\vert {p}_{i} \vert}{E} ) {e}^{+ i {p}^{μ} {x}_{μ} - {ip}^{μ} {x}_{μ}} )}_{p} \\ {( ( \frac{m}{E} - i \frac{\vert p \vert}{E} ) ( \frac{m}{E} + i \frac{\vert p \vert}{E} ) {e}^{i {p}^{μ} {x}_{μ} + {io}^{μ} {x}_{μ}} )}_{e} \\ = {( \frac{{m}^{2} + {p}_{i}^{2}}{{E}^{2}} {e}^{+ i {p}^{μ} {x}_{μ} - i {p}^{μ} {x}_{μ}} )}_{p} {( \frac{{m}^{2} + {p}^{2}}{{E}^{2}} {e}^{- i {p}^{μ} {x}_{μ} + i {p}^{μ} {x}_{μ}} )}_{e} \\ = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} \\ = {( ( \frac{E - m}{- \vert {p}_{i} \vert} ) {( \frac{- \vert {p}_{i } \vert}{E + m} )}^{- 1} ( {e}^{+ i {p}^{μ} {x}_{μ}} ) {( {e}^{+ i {p}^{μ} {x}_{μ}} )}^{- 1} )}_{p} \\ {( ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} )}_{e} \\ -> {( ( \begin{matrix}E - m & - \vert {p}_{i} \vert \\ - \vert {p}_{i} \vert & E + m\end{matrix} ) ( \begin{matrix}{s}_{e , -} {e}^{+ i Et} \\ {s}_{i , +} {e}^{+ i Et}\end{matrix} ) = 0 )}_{p} \\ {( ( \begin{matrix}E - m & - \vert p \vert \\ - \vert p \vert & E + m\end{matrix} ) ( \begin{matrix}{s}_{e , +} {e}^{- i Et} \\ {s}_{i , -} {e}^{i Et}\end{matrix} ) = 0 )}_{e} \\ -> ( \begin{matrix}{( ( \begin{matrix}E - e φ - m & - σ \cdot ( {p}_{i} - e A ) \\ - σ \cdot ( {p}_{i} - e A ) & E - e φ + m\end{matrix} ) ( \begin{matrix}{S}_{e , -} {e}^{+ i Et} \\ {S}_{i , +} {e}^{+ i Et}\end{matrix} ) = 0 )}_{p} \\ {( ( \begin{matrix}E + e φ - m & - σ \cdot ( p + e A ) \\ - σ \cdot ( p + e A ) & E + e φ + m\end{matrix} ) ( \begin{matrix}{S}_{e , +} {e}^{- i Et} \\ {S}_{i , -} {e}^{- i Et}\end{matrix} ) = 0 )}_{e}\end{matrix} )\end{matrix}$$
where ( )ₑ denotes electron, ( )ₚ denotes proton and (( )ₑ( )ₚ) denotes an electron-proton system.

9: A method as in claim 6 wherein said elementary particle comprises an electron and said first representation is modified to include a unspinized proton, said unspinized proton being modeled as a second elementary particle, and interaction fields of said electron and said unspinized proton, said modified first representation comprising:
$$\begin{matrix}1 = {e}^{i 0} \\ = {e}^{i 0} {e}^{i 0} {e}^{i 0} {e}^{i 0} \\ = {( {e}^{i 0} {e}^{i 0} )}_{p} {( {e}^{i 0} {e}^{i 0} )}_{e} \\ = {( {e}^{+ iL - iM} {e}^{+ iM - iM} )}_{p} {( {e}^{- iL + iL} {e}^{- iM + iM} )}_{e} \\ = {( ( cos L + i sin L ) ( cos L - i sin L ) {e}^{+ iM - iM} )}_{p} ( ( cos L - i sin L ) ( cos L + i sin L ) \\ { {e}^{- iM + iM} )}_{e} \\ = {( ( \frac{m}{E} + i \frac{\vert {p}_{i} \vert}{E} ) ( \frac{m}{E} - i \frac{\vert {p}_{i} \vert}{E} ) {e}^{+ i {p}^{μ} {x}_{μ} - {ip}^{μ} {x}_{μ}} )}_{p} \\ {( ( \frac{m}{E} - i \frac{\vert p \vert}{E} ) ( \frac{m}{E} + i \frac{\vert p \vert}{E} ) {e}^{i {p}^{μ} {x}_{μ} + {io}^{μ} {x}_{μ}} )}_{e} \\ = {( \frac{{m}^{2} + {p}_{i}^{2}}{{E}^{2}} {e}^{+ i {p}^{μ} {x}_{μ} - i {p}^{μ} {x}_{μ}} )}_{p} {( \frac{{m}^{2} + {p}^{2}}{{E}^{2}} {e}^{- i {p}^{μ} {x}_{μ} + i {p}^{μ} {x}_{μ}} )}_{e} \\ = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} \\ = {( ( \frac{E - m}{- \vert {p}_{i} \vert} ) {( \frac{- \vert {p}_{i } \vert}{E + m} )}^{- 1} ( {e}^{+ i {p}^{μ} {x}_{μ}} ) {( {e}^{+ i {p}^{μ} {x}_{μ}} )}^{- 1} )}_{p} \\ {( ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} )}_{e} \\ -> {( ( \begin{matrix}E - m & - \vert {p}_{i} \vert \\ - \vert {p}_{i} \vert & E + m\end{matrix} ) ( \begin{matrix}{s}_{e , -} {e}^{+ i Et} \\ {s}_{i , +} {e}^{+ i Et}\end{matrix} ) = 0 )}_{p} \\ {( ( \begin{matrix}E - m & - \vert p \vert \\ - \vert p \vert & E + m\end{matrix} ) ( \begin{matrix}{s}_{e , +} {e}^{- i Et} \\ {s}_{i , -} {e}^{i Et}\end{matrix} ) = 0 )}_{e} \\ -> ( \begin{matrix}{( ( \begin{matrix}E - e φ - m & - \vert {p}_{i} - e A \vert \\ - \vert {p}_{i} - e A \vert & E - e φ + m\end{matrix} ) ( \begin{matrix}{S}_{e , -} {e}^{+ i Et} \\ {S}_{i , +} {e}^{+ i Et}\end{matrix} ) = 0 )}_{p} \\ {( ( \begin{matrix}E + e φ - V - m & - σ \cdot ( p + e A ) \\ - σ \cdot ( p + e A ) & E + e φ - V + m\end{matrix} ) ( \begin{matrix}{S}_{e , +} {e}^{- i Et} \\ {S}_{i , -} {e}^{- i Et}\end{matrix} ) = 0 )}_{e}\end{matrix} )\end{matrix}$$
where ( )ₑ denotes electron, ( )ₚ denotes unspinized proton and (( )ₑ( )ₚ) denotes an electron-unspinized proton system.

10: A model for presenting and/or modeling generation, sustenance and evolution of an elementary particle, as a research aide, teaching tool and/or game, comprising:
a drawing which represents said generation, sustenance and evolution of said elementary particle, said drawing comprising:
$$\begin{matrix}1 = {e}^{i 0} \\ = {e}^{i 0} {e}^{i 0} \\ = {e}^{iL + iL} {e}^{- iM + iM} \\ = {L}_{e} {L}_{i}^{- 1} ( {e}^{- iM} ) {( {e}^{- iM} )}^{- 1} -> \\ ( {L}_{M , e} {L}_{M , i} ) ( \begin{matrix}{A}_{e} {e}^{- iM} \\ {A}_{i} {e}^{- iM}\end{matrix} ) = {L}_{M} ( \begin{matrix}{ψ}_{e} \\ {ψ}_{i}\end{matrix} ) = 0\end{matrix}$$
where e is natural exponential base, i is imaginary unit, L is a first phase, M is a second phase, Aₑe^{-iM}=ψₑ represents external object, Aᵢe^{-iM}=ψᵢ represents internal object, Lₑ represents external rule, Lᵢ represents internal rule, L=(L_{M,e} L_{M,i}) represents matrix rule, L_{M,e} represents external matrix rule and L_{M,i} represents internal matrix rule; and
a device for presenting and/or modeling said drawing.

11: A model as in claim 10 wherein said external object comprises of an external wave function; said internal object comprises of an internal wave function; said elementary particle comprises of a fermion, boson or unspinized particle; said matrix rule containing an energy operator E→i∂ₜ, momentum operator p→−i∇, spin operator σ where σ=(σ₁, σ₂, σ₃) are Pauli matrices, spin operator S where S=(s₁, s₂, s₃) are spin 1 matrices, and/or mass; said matrix rule further having a determinant containing E²−p²−m²=0, E²−p²=0, E²−m²=0, or 0²−p²−m²=0; c=1 where cis speed of light; and [symbol] =1 where [symbol] is reduced Planck constant.

12: A model as in claim 11 wherein said drawing of said generation, sustenance and evolution of said elementary particle comprises:
$$1 = {e}^{i 0} = {e}^{i 0} {e}^{i 0} = {e}^{+ i L - i L} {e}^{+ i M - i M} = ( cos L + i sin L ) ( cos L - i sin L ) {e}^{+ i M - i M} = ( \frac{m}{E} + i \frac{\vert p \vert}{E} ) ( \frac{m}{E} - i \frac{\vert p \vert}{E} ) {e}^{+ i {p}^{μ} {x}_{μ} - i {p}^{μ} {x}_{μ}} = ( \frac{{m}^{2} + {p}^{2}}{{E}^{2}} ) {e}^{+ i {p}^{μ} {x}_{μ} - i {p}^{μ} {x}_{μ}} = \frac{{E}^{2} - {m}^{2}}{{p}^{2}} {e}^{+ i {p}^{μ} {x}_{μ} - i {p}^{μ} {x}_{μ}} = ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} \to \frac{E - m}{- \vert p \vert} {e}^{- i {p}^{μ} {x}_{μ}} = \frac{- \vert p \vert}{E + m} {e}^{- i {p}^{μ} {x}_{μ}} \to \frac{E - m}{- \vert p \vert} {e}^{- i {p}^{μ} {x}_{μ}} - \frac{- \vert p \vert}{E + m} {e}^{- i {p}^{μ} {x}_{μ}} = 0 \\ \to ( \begin{matrix}E - m & - \vert p \vert \\ - \vert p \vert & E + m\end{matrix} ) ( \begin{matrix}{a}_{e , +} {e}^{- i {p}^{μ} {x}_{μ}} \\ {a}_{i , -} {e}^{- i {p}^{μ} {x}_{μ}}\end{matrix} ) = 0 \\ \to ( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( {L}_{M , e} {L}_{M , i} ) ( \begin{matrix}{ψ}_{e , +} \\ {ψ}_{i , -}\end{matrix} ) = 0 or \\ ( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( {L}_{M , e} {L}_{M , i} ) ( \begin{matrix}{ψ}_{e , +} \\ {ψ}_{i , -}\end{matrix} ) = 0$$
where
$$( \begin{matrix}E - m & - \vert p \vert \\ - \vert p \vert & E + m\end{matrix} ) ( \begin{matrix}{a}_{e , +} {e}^{- i {p}^{μ} {x}_{μ}} \\ {a}_{i , -} {e}^{- i {p}^{μ} {x}_{μ}}\end{matrix} ) = 0$$
is a first equation for said unspinized particle,
$$( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0$$
is Dirac equation in Dirac form for said fermion, and
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0$$
is a first equation for said boson;
$$1 = {e}^{i 0} = {e}^{i 0} {e}^{i 0} = {e}^{+ i L - i L} {e}^{+ i M - i M} = ( cos L + i sin L ) ( cos L - i sin L ) {e}^{+ i M - i M} = ( \frac{m}{E} + i \frac{\vert p \vert}{E} ) ( \frac{m}{E} - i \frac{\vert p \vert}{E} ) {e}^{+ i {p}^{μ} {x}_{μ} - i {p}^{μ} {x}_{μ}} = ( \frac{{m}^{2} + {p}^{2}}{{E}^{2}} ) {e}^{+ i {p}^{μ} {x}_{μ} - i {p}^{μ} {x}_{μ}} = \frac{{E}^{2} - {p}^{2}}{{m}^{2}} {e}^{+ i {p}^{μ} {x}_{μ} - i {p}^{μ} {x}_{μ}} = ( \frac{E - \vert p \vert}{- m} ) {( \frac{- m}{E + \vert p \vert} )}^{- 1} ( {e}^{- i {p}^{μ} {x}_{μ}} ) {( {e}^{- i {p}^{μ} {x}_{μ}} )}^{- 1} \to \frac{E - \vert p \vert}{- m} {e}^{- i {p}^{μ} {x}_{μ}} = \frac{- m}{E + \vert p \vert} {e}^{- i {p}^{μ} {x}_{μ}} \to \frac{E - \vert p \vert}{- m} {e}^{- i {p}^{μ} {x}_{μ}} - \frac{- m}{E + \vert p \vert} {e}^{- i {p}^{μ} {x}_{μ}} = 0 \to ( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) = 0 \\ \to ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = ( {L}_{M , e} {L}_{M , i} ) ( \begin{matrix}{ψ}_{e , l} \\ {ψ}_{i , r}\end{matrix} ) = 0 or \\ ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = ( {L}_{M , e} {L}_{M , i} ) ( \begin{matrix}{ψ}_{e , l} \\ {ψ}_{i , r}\end{matrix} ) = 0$$
where
$$( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) = 0$$
is a second equation for said unspinized particle,
$$( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
is Dirac equation in Weyl form for said fermion, and
$$( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
is a second equation for said boson;
$$1 = {e}^{i 0} = {e}^{i 0} {e}^{i 0} = {e}^{+ i L - i L} {e}^{+ i M - i M} = ( cos L + i sin L ) ( cos L - i sin L ) {e}^{+ i M - i M} = ( \frac{m}{E} + i \frac{\vert p \vert}{E} ) ( \frac{m}{E} - i \frac{\vert p \vert}{E} ) {e}^{+ i {p}^{μ} {x}_{μ} - i {p}^{μ} {x}_{μ}} = ( \frac{E}{- m + i \vert p \vert} ) {( \frac{- m - i \vert p \vert}{E} )}^{- 1} ( {e}^{- i {p}^{μ} {x}_{μ}} ) {( {e}^{- i {p}^{μ} {x}_{μ}} )}^{- 1} \to \frac{E}{- m + i \vert p \vert} {e}^{- i {p}^{μ} {x}_{μ}} = \frac{- m - i \vert p \vert}{E} {e}^{- i {p}^{μ} {x}_{μ}} \to \frac{E}{- m + i \vert p \vert} {e}^{- i {p}^{μ} {x}_{μ}} - \frac{- m - i \vert p \vert}{E} {e}^{- i {p}^{μ} {x}_{μ}} = 0 \\ \to ( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0 \\ \to ( \begin{matrix}E & - m - iσ \cdot p \\ - m + iσ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = ( {L}_{M , e} {L}_{M , i} ) ( \begin{matrix}{ψ}_{e} \\ {ψ}_{i}\end{matrix} ) = 0 or \\ ( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = ( {L}_{M , e} {L}_{M , i} ) ( \begin{matrix}{ψ}_{e} \\ {ψ}_{i}\end{matrix} ) = 0$$
where
$$( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0$$
is a third equation for said unspinized particle,
$$( \begin{matrix}E & - m - iσ \cdot p \\ - m + iσ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is Dirac equation in a third form for said fermion, and
$$( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is a third equation for said boson; or
$$1 = {e}^{i 0} = {e}^{i 0} {e}^{i 0} = {e}^{+ i L - i L} {e}^{+ i M - i M} = ( cos L + i sin L ) ( cos L - i sin L ) {e}^{+ i M - i M} = ( \frac{m}{E} + i \frac{\vert {p}_{i} \vert}{E} ) ( \frac{m}{E} - i \frac{\vert {p}_{i} \vert}{E} ) {e}^{+ i {p}^{μ} {x}_{μ} - i {p}^{μ} {x}_{μ}} = ( \frac{{m}^{2} + {p}_{i}^{2}}{{E}^{2}} ) {e}^{+ i {p}^{μ} {x}_{μ} - i {p}^{μ} {x}_{μ}} = \frac{{E}^{2} - {m}^{2}}{{p}_{i}^{2}} {e}^{+ i {p}^{μ} {x}_{μ} - i {p}^{μ} {x}_{μ}} = ( \frac{E - m}{- \vert {p}_{i} \vert} ) {( \frac{- \vert {p}_{i} \vert}{E + m} )}^{- 1} ( {e}^{- i {p}^{μ} {x}_{μ}} ) {( {e}^{- i {p}^{μ} {x}_{μ}} )}^{- 1} \to \frac{E - m}{- \vert {p}_{i} \vert} {e}^{- i {p}^{μ} {x}_{μ}} = \frac{- \vert {p}_{i} \vert}{E + m} {e}^{- i {p}^{μ} {x}_{μ}} \to \frac{E - m}{- {p}_{i}} {e}^{- i {p}^{μ} {x}_{μ}} - \frac{- \vert {p}_{i} \vert}{E + m} {e}^{- i {p}^{μ} {x}_{μ}} = 0 \\ \to ( \begin{matrix}E - m & - \vert {p}_{i} \vert \\ - \vert {p}_{i} \vert & E + m\end{matrix} ) ( \begin{matrix}{s}_{e , +} {e}^{- i Et} \\ {s}_{i , -} {e}^{- i Et}\end{matrix} ) = 0 \\ \to ( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = ( {L}_{M , e} {L}_{M , i} ) ( \begin{matrix}{ψ}_{e , +} \\ {ψ}_{i , -}\end{matrix} ) = 0 or \\ ( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = ( {L}_{M , e} {L}_{M , i} ) ( \begin{matrix}{ψ}_{e , +} \\ {ψ}_{i , -}\end{matrix} ) = 0$$
where
$$( \begin{matrix}E - m & - \vert {p}_{i} \vert \\ - \vert {p}_{i} \vert & E + m\end{matrix} ) ( \begin{matrix}{s}_{e , +} {e}^{- i Et} \\ {s}_{i , -} {e}^{- i Et}\end{matrix} ) = 0$$
is a first equation for said unspinized particle with said imaginary momentum pᵢ,
$$( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is Dirac equation in Dirac form for said fermion with said imaginary momentum pᵢ, and
$$( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is a first equation for said boson with said imaginary momentum pᵢ.

13: A model as in claim 12 wherein said elementary particle comprises of:
an electron, equation of said electron being modeled as:
$$( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a positron, equation of said positron being modeled as:
$$( \begin{matrix}E - m & - σ \cdot p \\ - σ \cdot p & E + m\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0$$
$$or \\ ( \begin{matrix}E & - m - i σ \cdot p \\ - m + i σ \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massless neutrino, equation of said neutrino being modeled as:
$$( \begin{matrix}E & - σ \cdot p \\ - σ \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & \\ & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - i σ \cdot p \\ + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
A massless antineutrino, equation of said antineutrino being modeled as:
$$( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a massive spin 1 boson, equation of said massive spin 1 boson being modeled as:
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a massive spin 1 antiboson, equation of said massive spin 1 antiboson being modeled as:
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a massless spin 1 boson, equation of said massless spin 1 boson being modeled as:
$$( \begin{matrix}E & - s \cdot p \\ - s \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( \begin{matrix}E & - s \cdot p \\ - s \cdot p & E\end{matrix} ) ( \begin{matrix}E \\ i B\end{matrix} ) = 0 , \\ ( \begin{matrix}E - s \cdot p & \\ & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - i s \cdot p \\ + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
where
$$( \begin{matrix}E & - s \cdot p \\ - s \cdot p & E\end{matrix} ) ( \begin{matrix}E \\ i B\end{matrix} ) = 0$$
is equivalent to Maxwell equation
$$( \begin{matrix}{\partial }_{t} E = ∇ \times B \\ {\partial }_{t} B = - ∇ \times E\end{matrix} ) ;$$
a massless spin 1 antiboson, equation of said massless spin 1 antiboson being modeled as:
$$( \begin{matrix}E & - s \cdot p \\ - s \cdot p & E\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - s \cdot p & \\ & E + s \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0$$
$$or \\ ( \begin{matrix}E & - i s \cdot p \\ - m + i s \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
an antiproton, equation of said antiproton being modeled as:
$$( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , l} {e}^{- i Et} \\ {S}_{i , r} {e}^{- i Et}\end{matrix} ) = 0$$
$$or \\ ( \begin{matrix}E & - m - i σ \cdot {p}_{i} \\ - m + i σ \cdot {p}_{i} & E\end{matrix} ) ( \begin{matrix}{S}_{e} {e}^{- i Et} \\ {S}_{i} {e}^{- i Et}\end{matrix} ) = 0 ; or$$
a proton, equation of said proton being modeled as:
$$( \begin{matrix}E - m & - σ \cdot {p}_{i} \\ - σ \cdot {p}_{i} & E + m\end{matrix} ) ( \begin{matrix}{S}_{e , -} {e}^{+ i Et} \\ {S}_{i , +} {e}^{+ i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , r} {e}^{+ i Et} \\ {S}_{i , l} {e}^{+ i Et}\end{matrix} ) = 0$$
$$or \\ ( \begin{matrix}E & - m - i σ \cdot {p}_{i} \\ - m + i σ \cdot {p}_{i} & E\end{matrix} ) ( \begin{matrix}{S}_{e} {e}^{+ i Et} \\ {S}_{i} {e}^{+ i Et}\end{matrix} ) = 0.$$

14: A model as in claim 12 wherein said elementary particle comprises an electron and said drawing is modified to include a proton, said proton being modeled as a second elementary particle, and interaction fields of said electron and said proton, said modified drawing comprising:
$$\begin{matrix}1 = {e}^{i 0} \\ = {e}^{i 0} {e}^{i 0} {e}^{i 0} {e}^{i 0} \\ = {( {e}^{i 0} {e}^{i 0} )}_{p} {( {e}^{i 0} {e}^{i 0} )}_{e} \\ = {( {e}^{+ iL - iM} {e}^{+ iM - iM} )}_{p} {( {e}^{- iL + iL} {e}^{- iM + iM} )}_{e} \\ = {( ( cos L + i sin L ) ( cos L - i sin L ) {e}^{+ iM - iM} )}_{p} \\ {( ( cos L - i sin L ) ( cos L + i sin L ) {e}^{- iM + iM} )}_{e} \\ = {( ( \frac{m}{E} + i \frac{\vert {p}_{i} \vert}{E} ) ( \frac{m}{E} - i \frac{\vert {p}_{i} \vert}{E} ) {e}^{+ i {p}^{μ} {x}_{μ} - i {p}^{μ} {x}_{μ}} )}_{p} \\ {( ( \frac{m}{E} - i \frac{\vert p \vert}{E} ) ( \frac{m}{E} + i \frac{\vert p \vert}{E} ) {e}^{- i {p}^{μ} {x}_{μ} + i {p}^{μ} {x}_{μ}} )}_{e} \\ = {( \frac{{m}^{2} + {p}_{i}^{2}}{{E}^{2}} {e}^{i {p}^{μ} {x}_{μ} - i {p}^{μ} {x}_{μ}} )}_{p} {( \frac{{m}^{2} + {p}^{2}}{{E}^{2}} {e}^{- i {p}^{μ} {x}_{μ} + i {p}^{μ} {x}_{μ}} )}_{e} \\ = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} \\ = {( ( \frac{E - m}{- \vert {p}_{i} \vert} ) {( \frac{- \vert {p}_{i} \vert}{E + m} )}^{- 1} ( {e}^{+ i {p}^{μ} {x}_{μ}} ) {( {e}^{+ i {p}^{μ} {x}_{μ}} )}^{- 1} )}_{p} \\ {( ( \frac{E - m}{- \vert p \vert} ) {( \frac{- \vert p \vert}{E + m} )}^{- 1} ( {e}^{+ i {p}^{μ} {x}_{μ}} ) {( {e}^{+ i {p}^{μ} {x}_{μ}} )}^{- 1} )}_{e} \\ -> {( ( \begin{matrix}E - m & - \vert {p}_{i} \vert \\ - \vert {p}_{i} \vert & E + m\end{matrix} ) ( \begin{matrix}{s}_{e , -} {e}^{+ i Et} \\ {s}_{i , +} {e}^{+ i Et}\end{matrix} ) = 0 )}_{p} \\ {( ( \begin{matrix}E - m & - \vert p \vert \\ - \vert p \vert & E + m\end{matrix} ) ( \begin{matrix}{s}_{e , +} {e}^{- i Et} \\ {s}_{i , -} {e}^{- i Et}\end{matrix} ) = 0 )}_{e} \\ \to ( \begin{matrix}{( ( \begin{matrix}E - e φ - m & - σ \cdot ( {p}_{i} - e A ) \\ - σ \cdot ( p + e A ) & E + e φ + m\end{matrix} ) ( \begin{matrix}{S}_{e , -} {e}^{+ i Et} \\ {S}_{i , +} {e}^{+ i Et}\end{matrix} ) = 0 )}_{p} \\ {( ( \begin{matrix}E + e φ - m & - σ \cdot ( p + e A ) \\ - σ \cdot ( p + e A ) & E + e φ + m\end{matrix} ) ( \begin{matrix}{S}_{e , +} {e}^{- i Et} \\ {S}_{i , -} {e}^{- i Et}\end{matrix} ) = 0 )}_{e}\end{matrix} )\end{matrix}$$
where ( )ₑ denotes electron, ( )ₚ denotes proton and (( )ₑ( )ₚ) denotes an electron-proton system.

15: A model as in claim 12 wherein said elementary particle comprises an electron and said drawing is modified to include a unspinized proton, said unspinized proton being modeled as a second elementary particle, and interaction fields of said electron and said unspinized proton, said modified drawing comprising:
$$\begin{matrix}1 = {e}^{i 0} \\ = {e}^{i 0} {e}^{i 0} {e}^{i 0} {e}^{i 0} \\ = {( {e}^{i 0} {e}^{i 0} )}_{p} {( {e}^{i 0} {e}^{i 0} )}_{e} \\ = {( {e}^{+ iL - iM} {e}^{+ iM - iM} )}_{p} {( {e}^{- iL + iL} {e}^{- iM + iM} )}_{e} \\ = {( ( cos L + i sin L ) ( cos L - i sin L ) {e}^{+ iM - iM} )}_{p} \\ {( ( cos L - i sin L ) ( cos L + i sin L ) {e}^{- iM + iM} )}_{e} \\ = {( ( \frac{m}{E} + i \frac{\vert {p}_{i} \vert}{E} ) ( \frac{m}{E} - i \frac{\vert {p}_{i} \vert}{E} ) {e}^{+ i {p}^{μ} {x}_{μ} - i {p}^{μ} {x}_{μ}} )}_{p} \\ {( ( \frac{m}{E} - i \frac{\vert p \vert}{E} ) ( \frac{m}{E} + i \frac{\vert p \vert}{E} ) {e}^{- i {p}^{μ} {x}_{μ} + i {p}^{μ} {x}_{μ}} )}_{e} \\ = {( \frac{{m}^{2} + {p}_{i}^{2}}{{E}^{2}} {e}^{i {p}^{μ} {x}_{μ} - i {p}^{μ} {x}_{μ}} )}_{p} {( \frac{{m}^{2} + {p}^{2}}{{E}^{2}} {e}^{- i {p}^{μ} {x}_{μ} + i {p}^{μ} {x}_{μ}} )}_{e} \\ = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} \\ = {( ( \frac{E - m}{- \vert {p}_{i} \vert} ) {( \frac{- \vert {p}_{i} \vert}{E + m} )}^{- 1} ( {e}^{+ i {p}^{μ} {x}_{μ}} ) {( {e}^{+ i {p}^{μ} {x}_{μ}} )}^{- 1} )}_{p} \\ {( ( \frac{E - m}{- \vert p \vert} ) {( \frac{- \vert p \vert}{E + m} )}^{- 1} ( {e}^{+ i {p}^{μ} {x}_{μ}} ) {( {e}^{+ i {p}^{μ} {x}_{μ}} )}^{- 1} )}_{e} \\ -> {( ( \begin{matrix}E - m & - \vert {p}_{i} \vert \\ - \vert {p}_{i} \vert & E + m\end{matrix} ) ( \begin{matrix}{s}_{e , -} {e}^{+ i Et} \\ {s}_{i , +} {e}^{+ i Et}\end{matrix} ) = 0 )}_{p} \\ {( ( \begin{matrix}E - m & - \vert p \vert \\ - \vert p \vert & E + m\end{matrix} ) ( \begin{matrix}{s}_{e , +} {e}^{- i Et} \\ {s}_{i , -} {e}^{- i Et}\end{matrix} ) = 0 )}_{e} \\ \to ( \begin{matrix}{( ( \begin{matrix}E - e φ - m & - \vert {p}_{i} - e A \vert \\ - \vert {p}_{i} + e A \vert & E + e φ + m\end{matrix} ) ( \begin{matrix}{S}_{e , -} {e}^{+ i Et} \\ {S}_{i , +} {e}^{+ i Et}\end{matrix} ) = 0 )}_{p} \\ {( ( \begin{matrix}E + e φ - V - m & - σ \cdot ( p + e A ) \\ - σ \cdot ( p + e A ) & E + e φ - V + m\end{matrix} ) ( \begin{matrix}{S}_{e , +} {e}^{- i Et} \\ {S}_{i , -} {e}^{- i Et}\end{matrix} ) = 0 )}_{e}\end{matrix} )\end{matrix}$$
where ( )ₑ denotes electron, ( )ₚ denotes unspinized proton and (( )ₑ( )ₚ) denotes an electron-unspinized proton system.
